(19) United States
(12) Patent Application Publication
(10) Pub. No.: US 2023/0401590 A1
(43) Pub. Date: Dec. 14, 2023

(54) METHODS, SYSTEMS, ARTICLES OF MANUFACTURE, AND APPARATUS TO DETERMINE NEW PRODUCT METRICS USING CROSS-CHANNEL ANALYTICS

(71) Applicant: Nielsen Consumer LLC, Chicago, IL (US)

(72) Inventors: Juan Manuel Martinez Manzano, Madrid (ES); Madison R. Smith, Chicago, IL (US); Larry P. Menke, Chicago, IL (US)

(21) Appl. No.: 17/836,826

(22) Filed: Jun. 9, 2022

(51) Int. Cl. G06Q 30/02; G06K 9/62

(52) U.S. Cl. CPC G06Q 30/0202; G06Q 30/0201; G06K 9/6223; G06K 9/6265

(57) ABSTRACT

Methods, apparatus, systems, and articles of manufacture are disclosed for determining new product metrics using cross-channel analytics. An example apparatus includes processor circuitry to at least compare first products data associated with a first channel and second products data associated with a second channel to identify a product of interest corresponding to a product present in the first products data and not in the second products data, and third products corresponding to products present in both the first products data and the second products data, cluster the third products based on at least one metric to generate product clusters, for ones of the product clusters in the cluster output, calculate a ratio of a performance metric of the third products, and determine a value of a performance metric for the product of interest based on the first products data and a ratio of the performance metric.

### FIELD OF THE DISCLOSURE

This disclosure relates generally to market research, and, more particularly, to methods, systems, articles of manufacture, and apparatus to determine new product metrics using cross-channel analytics.

### BACKGROUND

Retailers generate assortment plans that aim to capture consumer needs and achieve incremental growth. With an abundance of available products for retailers to integrate in their assortments and thousands of products being added to the marketplace each year, building an assortment strategy is an increasingly complex task. As consumers adjust their purchasing dynamics, retailers may need to change their assortment to maintain sales. Knowing which products drive incremental sales for a retailer can be critical for achieving growth.

### BRIEF DESCRIPTION OF THE DRAWINGS

FIG. 1 is a schematic illustration of an example environment to collect retail measurement data from a plurality of sources that can be used across channels within the environment in accordance with the teachings of this disclosure.

FIG. 2 is a block diagram of an example system for cross-channel analysis in accordance with the teachings of this disclosure.

FIG. 3 is a block diagram of the example cross-channel analysis circuitry of FIG. 2.

FIG. 4 is an example products hierarchy that can be generated to model an assortment plan.

FIG. 5 is a schematic illustration of an example new product added to an example clustering output by example cross-channel analysis circuitry in accordance with the teachings of this disclosure.

FIG. 6 is a block diagram of an example implementation of the example cross-channel analysis circuitry of FIGS. 2 and 3.

FIGS. 7-11 are flowcharts representative of example machine readable instructions and/or example operations that may be executed by example processor circuitry to implement the cross-channel analysis circuitry of FIG. 2.

FIG. 12 is a block diagram of an example processing platform including processor circuitry structured to execute the example machine readable instructions and/or the example operations of FIGS. 7-11 to implement the cross-channel analysis circuitry of FIGS. 2 and 3.

FIG. 13 is a block diagram of an example implementation of the processor circuitry of FIG. 12.

FIG. 14 is a block diagram of another example implementation of the processor circuitry of FIG. 12.

FIG. 15 is a block diagram of an example software distribution platform (e.g., one or more servers) to distribute software (e.g., software corresponding to the example machine readable instructions of FIGS. 7-11) to client devices associated with end users and/or consumers (e.g., for license, sale, and/or use), retailers (e.g., for sale, re-sale, license, and/or sub-license), and/or original equipment manufacturers (OEMs) (e.g., for inclusion in products to be distributed to, for example, retailers and/or to other end users such as direct buy customers).

In general, the same reference numbers will be used throughout the drawing(s) and accompanying written description to refer to the same or like parts. The figures are not to scale. Instead, the thickness of the layers or regions may be enlarged in the drawings. Although the figures show layers and regions with clean lines and boundaries, some or all of these lines and/or boundaries may be idealized. In reality, the boundaries and/or lines may be unobservable, blended, and/or irregular.

As used herein, connection references (e.g., attached, coupled, connected, and joined) may include intermediate members between the elements referenced by the connection reference and/or relative movement between those elements unless otherwise indicated. As such, connection references do not necessarily infer that two elements are directly connected and/or in fixed relation to each other. As used herein, stating that any part is in “contact” with another part is defined to mean that there is no intermediate part between the two parts.

Unless specifically stated otherwise, descriptors such as “first,” “second,” “third,” etc., are used herein without imputing or otherwise indicating any meaning of priority, physical order, arrangement in a list, and/or ordering in any way, but are merely used as labels and/or arbitrary names to distinguish elements for ease of understanding the disclosed examples. In some examples, the descriptor “first” may be used to refer to an element in the detailed description, while the same element may be referred to in a claim with a different descriptor such as “second” or “third.” In such instances, it should be understood that such descriptors are used merely for identifying those elements distinctly that might, for example, otherwise share a same name.

As used herein, “approximately” and “about” modify their subjects/values to recognize the potential presence of variations that occur in real world applications. For example, “approximately” and “about” may modify dimensions that may not be exact due to manufacturing tolerances and/or other real world imperfections as will be understood by persons of ordinary skill in the art. For example, “approximately” and “about” may indicate such dimensions may be within a tolerance range of +/−10% unless otherwise specified in the below description. As used herein “substantially real time” refers to occurrence in a near instantaneous manner recognizing there may be real world delays for computing time, transmission, etc. Thus, unless otherwise specified, “substantially real time” refers to real time+/−1 second.

As used herein, the phrase “in communication,” including variations thereof, encompasses direct communication and/or indirect communication through one or more intermediary components, and does not require direct physical (e.g., wired) communication and/or constant communication, but rather additionally includes selective communication at periodic intervals, scheduled intervals, aperiodic intervals, and/or one-time events.

As used herein, “processor circuitry” is defined to include (i) one or more special purpose electrical circuits structured to perform specific operation(s) and including one or more semiconductor-based logic devices (e.g., electrical hardware implemented by one or more transistors), and/or (ii) one or more general purpose semiconductor-based electrical circuits programmable with instructions to perform specific operations and including one or more semiconductor-based logic devices (e.g., electrical hardware implemented by one or more transistors). Examples of processor circuitry include programmable microprocessors, Field Programmable Gate Arrays (FPGAs) that may instantiate instructions, Central Processor Units (CPUs), Graphics Processor Units (GPUs), Digital Signal Processors (DSPs), XPUs, or microcontrollers and integrated circuits such as Application Specific Integrated Circuits (ASICs). For example, an XPU may be implemented by a heterogeneous computing system including multiple types of processor circuitry (e.g., one or more FPGAs, one or more CPUs, one or more GPUs, one or more DSPs, etc., and/or a combination thereof) and application programming interface(s) (API(s)) that may assign computing task(s) to whichever one(s) of the multiple types of processor circuitry is/are best suited to execute the computing task(s).

### DETAILED DESCRIPTION

An assortment refers to a collection of goods or services offered by a retailer on or during any given period of time (e.g., per day). To increase category revenue growth and profitability, retailers desire a data-driven approach to expanding their product ranges, focusing on the potential for incremental sales growth. An assortment strategy that offers incrementality can lead to the retailer adding new products that reach a respective category sales potential without cannibalizing existing sales. With over 50 million potential products available in the marketplace, a common technique to simplify the complexity of an assortment strategy and to predict new product impact is to run simulations. For example, a retailer or a market research entity (e.g., on behalf of the retailer) may want to simulate how a new product would sell if the retailer were to offer the new product and/or how sales of the new product would affect sales of products the retailer currently sells (e.g., no affect, positive affect, cannibalization, etc.). As disclosed herein, a new product refers to a product a retailer does not currently sell and/or a product not available in a channel. Predicting new product impacts before implementing assortment changes allows retailers to assess different assortment approaches before establishing an ideal or otherwise profitable assortment for a specific store.

To simulate an effect of adding the new product to an assortment, there are a number of key metrics (e.g., performance metrics) about the new product that need to be estimated. At least one such metric is a rate at which the new product may sell, referred to herein as a rate of sale (ROS). The market research entity can speculate as to what the ROS for the new product might be, but such speculation is at best a guess, which causes the use of erroneous data to be used when introducing the new product into a sales environment. For instance, the erroneous data (e.g., inaccurate and/or otherwise incorrect ROS data) causes particular geographic distributions to be overestimated or underestimated regarding demand for the new product. Relying on erroneous data while implementing an assortment strategy can result in poor sales for the new product or one or more adjacent products. In some examples, relying on erroneous data can result in customer's shopping at an alternate store, further lowering a retailer's profitability. In some examples, the diminished aggregate sales may remain for an extended time period. Thus, it is important to accurately predict the success or failure of a new product(s) and the impact the new product(s) will have on another product(s).

In some examples, the market research entity can use (e.g., borrow) data from another retailer within a same channel to predict the ROS for the new product if the retailer of interest were to sell the new product. For example, the market research entity can use retail measurement data (e.g., sales data, product data, etc.) from a second retailer that sells the new product to estimate the ROS for the new product if the new product were added to the retailer of interest's assortment. However, there are instances in which the new product has not been sold within the channel and/or sales data from another retailer within the same channel is otherwise unavailable. A channel as disclosed herein refers to a grouping of stores based on, for example, a type of products sold. Example channels include, but are not limited to, food (e.g., grocery stores, etc.), mass merchandise (e.g., Walmart®, etc.), drug (e.g., Walgreens®, etc.), convenience, etc.

In some instances, the market research entity can utilize data from another channel in which the new product is being sold to predict the ROS and/or another performance metric of the new product associated with the retailer of interest. For example, the entity can use an existing level of a product hierarchy to estimate the ROS of the new product based on sales data for products in a same level of the product hierarchy. A product hierarchy is a data structure that segments products belonging to a certain category in successive hierarchical levels. For example, a product hierarchy for soft drinks can begin at a first level and segment the soft drinks category at lower levels. To illustrate, a first level can correspond to manufacturers of soft drinks (e.g., Coke®, Pepsi®, etc.). In some examples, a second level of the product hierarchy can segment each manufacturer into sub-categories such as format (e.g., bottle, can, etc.). Further down the product hierarchy, a third level can segment the formats into sizes (e.g., 16 ounce bottle, 1 liter bottle, etc.). It is understood, however, that product hierarchies can be segmented in any number of manners depending on the products included in the hierarchy.

The market research entity can select a node at a level (e.g., the second level) of a product hierarchy that is similar to the new product and utilize retail measurement data corresponding to that node to predict the ROS for the new product. This method is simple because the products in the hierarchy are already grouped based on a metric corresponding to the selected level of the hierarchy. However, this method does not provide the flexibility needed to enable precise predictions of the ROS for a new product. For example, using the second level of the hierarchy may not provide enough granularity to distinguish products within that level that more accurately belong in separate groups. For example, basing an ROS prediction for a new product on a specific manufacturer would include using retail measurement data for all soft drinks sold in the hierarchy for that manufacturer, excluding only soft drinks from other manufacturers. Further, the prediction would be based on retail measurement data for all soft drink packaging formats for the manufacturer, all flavors, etc. In some examples, this method results in unreasonably high or otherwise inaccurate sales predictions. Accordingly, this technical field of research needs an improved technique (e.g. computer implemented method) for predicting performance metrics of a new product that removes dependency on hierarchies and allows flexibility to choose metrics on which to group products.

Example methods, systems, articles of manufacture, and apparatus disclosed herein can be used to estimate (e.g., predict) a performance metric of a new product(s) that is not available in a consumer market using cross-channel assortment analytic techniques. Disclosed examples can be used to predict a rate of sales for a new product(s) using retail measurement data for products that sell in common between a market of interest (e.g., a focus market) and a market where the new product is selling (e.g., a benchmark market), thus removing guesswork from the estimation. In other words, examples disclosed herein analyze a set of existing market products that are similar to a new product(s) to be introduced into a focus market. In some examples, a granularity level of the focus and benchmark markets can differ. For example, the focus market and/or the benchmark market can be a specific retailer, a channel, a manufacturer, a store, etc. While examples disclosed herein are discussed in terms of a rate of sale (ROS) performance metric, disclosed examples can be used to predict other performance metrics in additional or alternative examples, such as sales per point of distribution (SPPD), volume sales, value sales, growth, product price, market share, etc.

Example methods, systems, articles of manufacture and apparatus disclosed herein identify a focus market (e.g., channel), which is a channel in which the new product may be integrated, and a benchmark market (e.g., channel), which is a channel in which the new product is currently being sold. In some examples, a retailer can submit a request (e.g., to a market research entity) that includes a first (e.g., focus, target, order, etc.) channel and a second (e.g., benchmark, reference, guide, sample, etc.) channel, and requests performance metric data for a new product(s) that the retailer could add to its assortment. In some examples, the new product can be a specific new product(s), a new category of products, or new products in a specific category that the retailer does not currently sell based on a comparison between products sold in the focus channel and products sold in the benchmark channel. In some examples, a manufacturer or other vendor can submit a similar request to identify gaps are in a market to, for example, convince a retailer to add a new product(s) to the retailer's assortment. In some examples, the market research entity may submit a similar request to provide a recommendation(s) to a retailer that includes products sold in other channels that the retailer may consider adding to its assortment. In additional or alternative examples, the request can be from another source interested in performance metrics for a new product.

Example methods, systems, articles of manufacture and apparatus extract focus channel data and benchmark channel data from at least one database. For example, the database can be one or more databases operated by the market research entity that includes market data (e.g., channel-specific information, geographic differences, etc.), product data (e.g., products, product attributes, categories, etc.), fact data (e.g., product sales data, distribution, price, etc.), and/or time data (e.g., when data was captured, when products were sold, etc.). A size of a database can be (e.g., excessively, relatively) large and/or complex. For example, a database related to products can include millions products sold by hundreds to thousands of retailers, with sales data spanning different periods of time associated with each product. For example, a database can include millions of products with each product including numerous details, enabling custom data aggregation based on product characteristics. In some examples, the database can include data for over 50 million products collected from nearly 900,000 retailers on a monthly basis, enabling true market and consumer understanding and trustworthy insights. In some such examples, the 900,000 retailers can (e.g., collectively) sell millions of products each day. In some examples, utilizing such large sets of data can result in increased accuracy of predictions based on the data.

Certain examples utilize the focus channel data to select, extract, and/or generate one or more hierarchies for a category(ies) corresponding to the new product(s). Certain examples aggregate the focus channel data into aggregated focus data (e.g., a focus channel products dataset). Certain examples aggregate the benchmark channel data into aggregated benchmark data (e.g., a benchmark channel products dataset). For example, the aggregated focus data and/or the aggregated benchmark data may include products sold by in the respective channel and corresponding retail measurement data such as sales data, price, UPCs, etc. In some examples, the aggregated focus data and/or aggregated benchmark data are in a table format. In some examples, the aggregated focus data and/or aggregated benchmark data include hundreds to millions of products.

Example methods, systems, articles of manufacture, and apparatus compare the aggregated focus data and the benchmark channel data to identify products that are sold in the benchmark channel, but not sold in the focus channel (e.g., new product(s)). Thus, some example methods, system, articles of manufacture, and apparatus can compare a first dataset of thousands of products to a second dataset of thousands of products. In some examples, the new product(s) can be added to the one or more hierarchies for a category(ies) of the new product(s). For example, certain examples can add a new node to the hierarchy that includes the new product. In some such examples, child nodes that are created below the new node follow segmentation rules as defined by sibling nodes in the hierarchy.

Example methods, systems, articles of manufacture and apparatus compare the aggregated focus data and the aggregated benchmark data to identify products that are sold in both the focus channel and the benchmark channel, referred to herein as common products. Thus, some example methods, system, articles of manufacture, and apparatus can compare the first dataset of thousands of products to the second dataset of thousands of products based on another search criterion. In some examples, disclosed systems and apparatus identify common products in a same category as the new product(s) or the new product(s) category. For example, if a retailer and/or a manufacturer identifies a specific new product or requests performance metrics for new products in a specific category, the category can correspond to the new product or the specified category, respectively. In some examples, if no products sell in both channels or the number of common products is below a threshold number, then no products from the benchmark channel would be used to predict the performance metric of the new product for the focus channel because the two channels would be too different in terms of the scope of products they carry and, therefore, in terms of the type of shoppers buying in both. In some such examples, a new benchmark channel may need to be selected and the process repeated. In some examples, only common products sold within a specific (e.g., threshold) period (e.g., recently sold products) are used for the cross-channel assortment analysis. For example, products sold beyond a specific period of time (e.g., one month) may be removed from a dataset of common products. However, other dates or time periods can be used in additional or alternative examples.

Typically, markets behave differently from each other in terms of consumer behavior. For example, a U.S. food channel will likely experience different sales or trends than a U.S. drug channel. For example, the U.S. food channel can experience more sales (e.g., overall and/or per product) than the U.S. drug channel. Accordingly, the benchmark channel data may need to be adjusted (e.g., scaled up or scaled down) before using the benchmark sales data for the new product to estimate focus channel sales data for the new product. To do so, examples disclosed herein group the common products based on selected metrics and compare the groups to the new product(s).

Disclosed methods, systems, articles of manufacture and apparatus select (e.g., identify, determine, choose, etc.) at least one metric on which to cluster or otherwise group the common products. Metrics can include, for example, price, velocity, distribution, size, format, manufacturer, etc. In some examples, the selected metrics correspond to characteristics of a specific new product or new product(s) in a specific category. In some examples, the metrics are used to define and/or determine whether two different products are alike.

Example methods, systems, and apparatus disclosed herein apply a clustering technique to the common products based on the selected metrics to create (e.g., produce, generate) groups of alike (e.g., similar) products. Clustering is a process of dividing a dataset(s) into groups, referred to herein as clusters, based on patterns identified in the dataset(s). Generally, a clustering technique uses an iterative approach to group items in a dataset into clusters that possess similar characteristics. Examples disclosed herein apply a k-means clustering technique to group alike products. However, other clustering techniques may be used additionally or alternatively, such as agglomerative clustering, spectral clustering, etc. Certain examples randomly select a number of clusters, k, in which to group the common products. In some examples, the number of clusters, k, can be determined using an evaluation method, such as an elbow method, a silhouette method and/or another technique. Examples disclosed herein thus generate k clusters of common products that are similar to each other based on the selected metrics. Disclosed examples cluster only the common products belonging to both channels and/or retailers. In some examples, the common products are clustered using the benchmark channel data. Examples disclosed herein calculate (e.g., identify, determine) a centroid data point for each of the groups generated by the clustering technique. Accordingly, k centroids will be calculated.

In some examples, clustering alike products facilitates identification of products selling in both channels that are similar to and/or different from a new product. Certain examples thus narrow down a number of products by group to be used as proxies to estimate a performance metric (e.g., ROS, etc.) and elasticities. In some examples, identifying products that are similar to a new product(s) enables a better estimation of sales in the focus channel based on the information for the like products that are selling in both channels. That is, the more alike the products belonging to a group are, the more accurate an end estimation can be. Thus, clustering alike products can be a critical step to accurately predict a performance metric for a new product.

Examples disclosed herein determine (e.g., calculate) a ratio of a performance metric between the focus channel and the benchmark channel. Certain examples determine a ratio of sales (e.g., a sales adjustment) between the focus channel and the benchmark channel. For example, the ratio of sales can be calculated by dividing sales for a plurality of focus channel products (e.g., within a cluster) by sales for the same plurality of benchmark channel products (e.g., within the cluster). In some examples, a ratio of sales is calculated for each of the k clusters.

Example methods, systems, articles of manufacture and apparatus add the new product(s) (e.g., product(s) only selling on the benchmark channel) to the clustering output. For example, the new product(s) can be added to the clustering output based on the selected metrics and associated benchmark data. Examples disclosed herein use the centroid data to determine a distance of each cluster's centroid to the new product(s). _{#}In some examples, one or more of the groups of products are used to predict a performance metric (e.g., ROS) for the new product(s), each having a different weight. For example, a weight of a group can be assigned to a cluster by determining an inverse squared distance of a centroid of the cluster from the new product. In this manner, a group that is further away (e.g., less alike) from the new product(s) will receive a lower weight than a group that is closer to (e.g., more alike) the new product(s). In some examples, the weights are applied to the ratios of sales to generate adjusted ratios of sales. In some examples, only a cluster closest to the new product(s) is used to estimate the performance metric.

Examples disclosed herein predict the ROS for the new product based on the ratio of sales or adjusted ratio of sales corresponding to at least one cluster. Certain examples predict the ROS for the new product by multiplying the ROS of the new product based on the benchmark channel data by the ratio of sales or adjusted ratio of sales to determine the ROS for the new product if it were to be sold by focus channel. Certain examples thus improve sales predictions when using products in different channels to predict sales for a new product in a channel of interest. Thus, at least one benefit of example systems, methods, apparatus and/or articles of manufacture disclosed herein is an opportunity to predict new product performance of a new product before deciding whether to add the new product to a retailer's assortment and/or deciding which other product(s) to modify (e.g., de-list, modify shelf allocation, etc.), thereby avoiding the overall diminished sales profits and/or revenue effects of a poor modification decision. Although identifying different product assortments to ensure aggregate sales, profits and/or revenue is possible for existing products based on, in part, analysis of historical sales data, new products do not have such historical sales data to facilitate forecasting efforts. Examples disclosed herein are able to search through datasets of thousands of products that include thousands of attributes to identify data of interest, and utilize the data of interest to generate clusters based on selected metrics to be used as proxies for predicting a performance metric of the new product.

Certain examples integrate the disclosed methods, systems, and apparatus into established workflows. Certain examples place the new products in an existing hierarchy(ies) used by a retailer in the focus channel for the category. For example, the market research entity can create and/or use existing processes to place the new product in a hierarchy and update other files associated with the placement of those new products to enable further predictions and/or forecasting. In some examples, an assortment for the focus channel is modeled based on products sold by the focus channel. For example, the generated product hierarchy or hierarchies can be used in combination with a generated relationship matrix to calculate impact coefficients reflecting the impact of a particular product on another product. In some such examples, the new product(s) can be added to the assortment model to generate updated coefficients to be used for simulations. In some examples, generated data is added to a platform having an interface for a market participant (e.g., a retailer, manufacturer, etc.) to access the data.

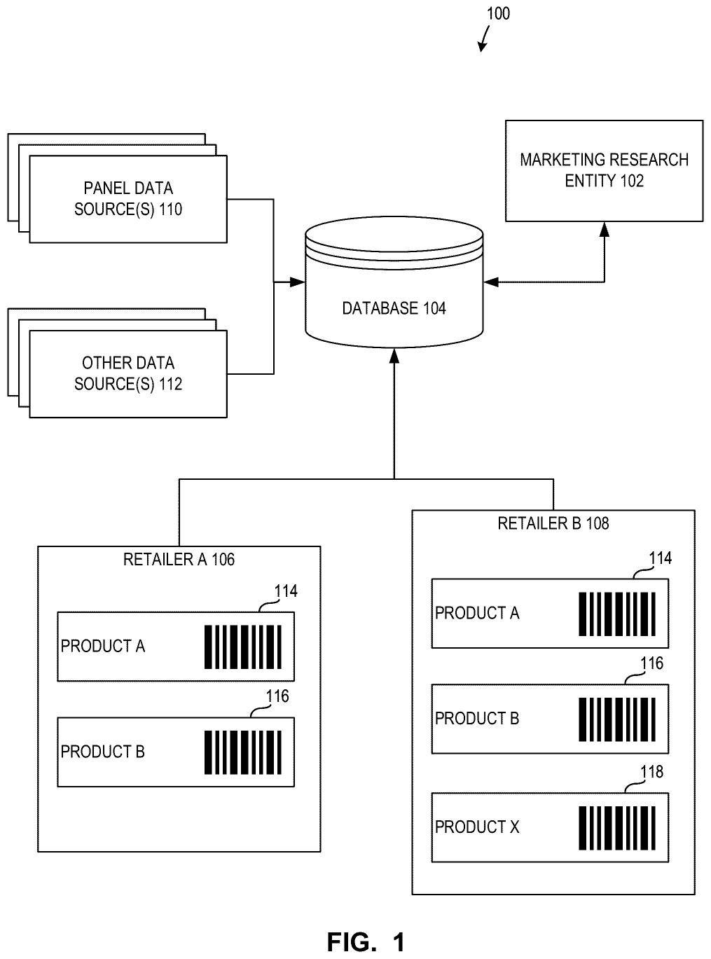

Referring now to the drawings, FIG. 1 is a schematic illustration of an example environment 100 for collecting data from which to gather insights in accordance with the teachings of this disclosure. The environment 100 includes an example market research entity 102, which can be, for example, an entity that collects purchase data from a plurality of sources to extract actionable information. Generally, marketing research entities provide manufacturers and retailers with a complete picture of the complex marketplace and actionable information that brands need to grow their businesses. To do so, the entities apply data analysis techniques to comprehensive data sets to extract insights. Accordingly, the market research entity 102 of FIG. 1 operates an example database 104, which stores the collected data (e.g., raw data) gathered from the plurality of sources. For example, the database 104 can include data collected from retailers, consumers, manufacturers, etc. In some examples, the marketing research entity 102 collects data for over 50 million product from nearly 900,000 retailers on a monthly basis. In some examples, such a large amount of data can enable better predictive performance than smaller sets of data.

The example database 104 of the illustrated example of FIG. 1 is implemented by any memor(ies), storage device(s) and/or storage disc(s) for storing data such as, for example, flash memory, magnetic media, optical media, etc. Furthermore, the data stored in the database 104 may be in any data format such as, for example, binary data, comma delimited data, tab delimited data, structured query language (SQL) structures, image data, etc. While in the illustrated example of FIG. 1 the database 104 is illustrated as a single database, the database 104 may be implemented by any number and/or type(s) of database 104. In some examples, the database 104 and/or a separate database(s) can be used to store data that has been analyzed data to extract information. For example, the data collected from the variety of sources and stored in the database 104 can be processed, enriched, analyzed and made presentable to end users for consumption.

The environment 100 of FIG. 1 includes an example first retailer (e.g., Retailer A) 106, an example second retailer (e.g., Retailer B) 108, an example panel data source(s) 110, and one or more other data sources 112. The retailers 106, 108, panel data sources 110 and/or the other data sources 112 periodically and/or aperiodically transmit data or other information to the database 104 (e.g., via a network). In some examples, the marketing research entity 102 uses the data to measure sales, price, distribution, etc. for a plurality of products and a plurality of retailers in the marketplace. In some examples, the data includes, but is not limited to, point-of-sale (POS) data, receipts, basket information from panel members, etc. For example, the market search entity 102 can utilize the POS data to capture units sold by a retailer with selling prices. The other data sources 112 can include, for example, other retailers, stores, manufacturers, data from purchase documents, advertisements, analysts, etc.

In some examples, retailer A 106 belongs to a first channel (e.g., food) in a universe (e.g., U.S. food), while retailer B 108 belongs to a different channel in the universe (e.g. U.S. mass merchandise). In the illustrated example of FIG. 1, retailer A 106 sells at least product A 114 and product B 116. Retailer A 106 may be considering adding another product to its assortment, such a product X 118. However, retailer A 106 may first want to predict performance metrics related to product X 118 if retailer A 106 were to sell product X 118 and how sales of product X 118 may affect sales of other products 114, 116. Product X 118 has never been sold in retailer A 108, nor in the U.S. food channel. However, product X 118 is sold by retailer B 108, which is in the U.S. mass merchandise (e.g., U.S. mass) channel.

Retailer A 106 may enlist the market research entity 102 to “borrow” information from retailer B 108 to determine performance metrics of the new product. For example, retailer A 106 may not have access to retail measurement data for retailer B 108. The market research entity 102 on the other hand may have access to the retail measurement data for retailer B 108 or an ability to retrieve retail measurement data corresponding to retailer B 108 or the U.S. mass channel. Accordingly, retailer A 106 may submit a request to the market research entity 102 to predict performance metrics for product X 118 based on retailer B's 108 sales data and/or sales data from the U.S. mass channel.

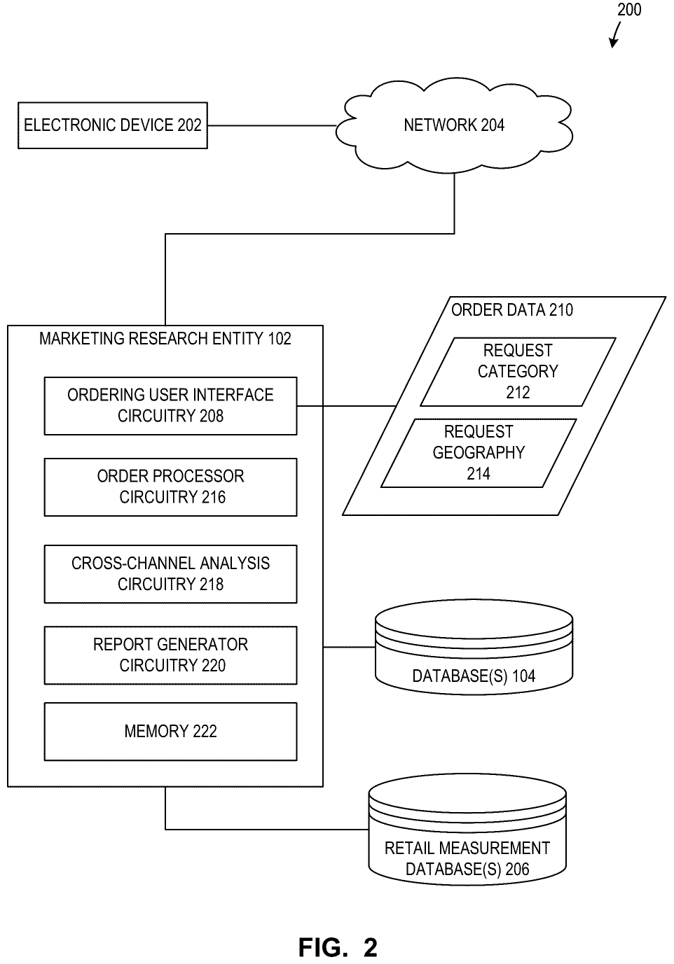

FIG. 2 is an example system 200 for determining performance metrics of a new product in accordance with the teachings of this disclosure. The system 200 includes the example market research entity 102 of FIG. 1. The market research entity 102 may be implemented by one or more servers. In some examples, the market research entity 102 can be a physical processing center. Additionally or alternatively, the market research entity 102 can be implemented via a cloud service (e.g., AWS®, etc.).

In the illustrated example of FIG. 2, an example electronic device 202 is communicatively coupled to the market research entity 102 via an example network 204. The electronic device 202 can be associated with a retailer corresponding to a channel, such as retailer A 106 of FIG. 1 corresponding to the U.S. food channel. The electronic device 202 can be, for example, a personal computing (PC) device such as a laptop, a smartphone, an electronic tablet, a hybrid or convertible PC, etc. used by the retailer to request performance metrics for a new product(s) the retailer is contemplating adding to its assortment. In some examples, the retailer may request performance metrics for any new products sold in a different channel that the retailer does not currently sell.

The example network 204 of FIG. 2 is the Internet. However, the network 204 may be implemented using any network over which data can be transferred. The example network 204 may be implemented using any suitable wired and/or wireless network(s) including, for example, one or more data buses, one or more Local Area Networks (LANs), one or more wireless LANs, one or more cellular networks, one or more private networks, one or more public networks, among others. In additional or alternative examples, the network 204 is an enterprise network (e.g., within businesses, corporations, etc.), a home network, among others.

The market research entity 102 is communicatively coupled to an example retail measurement database(s) 206. The retailer measurement database 206 can be a database that includes analyzed and/or processed data (e.g., based on raw data that was collected from a plurality of sources). In some examples, the retailer measurement database 206 include data from the example database 104 of FIG. 1 that has been analyzed or otherwise processed (e.g., validated, enhanced, etc.). In some examples, the retail measurement database 206 is implemented as a data as a service (DaaS) platform.

In some examples, the retail measurement database 206 includes four primary dimensions, including a market dimension, a product dimension, a facts dimension, and a time dimension. The market dimension can include an indication of where purchases are made (e.g., country, region, province, city, etc.) and can be organized according to characteristics of stores within each market, such as channels, geographical areas, etc. The product dimension can include characteristics and/or attributes used to arrange products, such as product classifications (e.g., category, manufacturer, brand) and/or physical attributes of the products (e.g., segments) (e.g., size, flavor, packaging type). The facts dimension can include metrics for specific markets and periods, such as how much product is sold, value, value share, price, etc. In some examples, the facts (e.g., metrics) are captured to facilitate analysis of performance across products, markets, and/or time. The time dimension can include an indication of when a product was sold (e.g., purchased by a consumer) and data periods. Data periods indicate how frequently data is received from a source (e.g., monthly, bimonthly, weekly, etc.). In some examples, the dimensions of the retail measurement database 206 are organized in hierarchies, enabling data access through logical groupings.

In some examples, the retail measurement database 206 includes a plurality of products with corresponding details including, but not limited to, unique product codes (e.g., universal product codes (UPCs), international article numbers (EANs), etc.), product-level hierarchy information, product descriptions, market breakdown, total weekly sales value and units sold, distribution values, etc. In some examples, products stored in the retail measurement database 206 are associated with more than 5,000 product facts (e.g., characteristics, data, etc.) with detailed and enhanced data, including volume, share, distribution, price, promotion, etc. In some examples, product information can be accessed by channel, region, province, or city.

The market research entity 102 includes example ordering user interface circuitry 208, which is structured to provide an interface through which a market participant (e.g., a retailer, a manufacturer, a market research entity, etc.) can request new product(s) performance metric information. In some examples, the market participant provides example order data 210 to the market research entity 102 via the ordering user interface circuitry 208. For example, the order data 210 can include an example request category 212 and an example request geography 214. The request category 212 can include a specific new product for a focus market and/or a category of products (e.g., soft drinks) for which to predict a performance metric. For example, the market participant may request performance metrics for any new products sold in the benchmark market that are not sold in the focus market. The request geography 214 can include a country (e.g., the U.S.), a specific geographic area, etc. In some examples, the request geography 214 can include a focus market (e.g., a retailer, a channel, etc.) and a benchmark market (e.g., a retailer, a channel, etc.). The channel can be, for example, food/grocery, mass merchandize, drug, dollar, club, military, convenience, pet, liquor, specialty, natural/organize supermarket, etc. In some examples, the order data 210 includes additional or alternative information.

The market research entity 102 includes example order processor circuitry 216, which is structured to interpret and prepare the order data 210 received from the market participant. In some examples, the order processor circuitry 216 can receive the order data 210 from the ordering user interface circuitry 208 and identify data to be extracted. For example, the order processor circuitry 216 can identify the focus channel from which to extract data and the benchmark channel from which to extract data. In some examples, the order processor circuitry 216 identifies a category of products to limit an amount of data that needs to be extracted. In some examples, the order processor circuitry 216 can transmit the order details to example cross-channel analysis circuitry 218 to be processed.

The market research entity 102 includes example cross-channel analysis circuitry 218, which is structured to process the order received from the market participant. The cross-channel analysis circuitry 218, which is discussed in greater detail below, is structured to predict a performance metric(s) for a new product(s). For example, the cross-channel analysis circuitry 218 extracts data corresponding to the focus channel and data corresponding to the benchmark channel. In some examples, the cross-channel analysis circuitry 218 compares the focus channel data and the benchmark channel data to identify products that both the focus channel and the benchmark channel sell (e.g., common products). In some examples, the cross-channel analysis circuitry 218 compares the focus channel data and the benchmark channel data to identify products the benchmark channel sells, but the focus channel does not sell (e.g., new products).

In some examples, the cross-channel analysis circuitry 218 clusters the common products based on selected metrics, such as price (e.g., product price), manufacturer (e.g., versus private label), size or format (e.g., bottle, can, sizes of packaging, etc.), promotional product versus standard product, etc. In some examples, the selected metrics can include product velocity (e.g., high rate of sale, low rate of sale, etc.) in a manner that controls for size of store (e.g., by determining adjustments for sales based on store size). In some examples, the selected metrics can include distribution (e.g., whether a product is highly distributed or not). In some examples, the selected metrics can include seasonality of a product (e.g., whether the product is sold in certain periods of the year). In some examples, the selected metrics can include a sensitivity flag that indicates whether a product includes a private label, such as a store brand label. In some examples, products that include a sensitivity flag are not used to predict a performance metric for a new product because a retailer may not want sales data for the product having the sensitivity flag to be revealed. In some examples, a number of metrics used to cluster the common products is limited. For example, a point can be reached at which adding more metrics adds redundancy without increasing an accuracy of a performance metric prediction.

In some examples, grouping products based on the selected metrics enables grouping of products that are alike in terms of the selected metric(s). For example, clustering products based on size or format may lead to grouping products that are more alike than products that are grouped solely by manufacture (e.g., as discussed above). For example, a consumer may tend to choose between different types of 2 Liter bottles of soda regardless of manufacturer rather than determining to purchase soda based solely on a specific manufacturer.

In disclosed examples, the cross-channel analysis circuitry 218 uses the clusters to scale performance data that exists (e.g., the benchmark data) that is used to predict performance data that does not exist (e.g., for the focus channel in which the product has not sold). In some examples, only the benchmark channel products are assigned to clusters during the clustering process. However, because the clustered products are common products, disclosed examples thus cluster the focus channel products as well. That is, the clusters include products that are sold by both the benchmark channel and the focus channel. Thus, by comparing performance data for products within a metric (e.g., price, format, etc.), a ratio can be determined that identifies a difference in the performance data between the benchmark channel and the focus channel. For example, the benchmark data can be scaled by taking an average of how much more the benchmark channel does in terms of sales than the focus market, or vice versa.

The market research entity 102 includes example report generator circuitry 220, which is structured to generate a report for the market participant requester based on results obtained by the cross-channel analysis circuitry 218. For example, the report can include an indication of new products that a retailer within the focus channel could add to its assortment. In some examples, the report includes at least one performance metric for the new product(s), such as a ROS(s) for the new product(s). In some examples, the report can include information concerning effects on other products caused by adding the new product(s) to a retailer's assortments. Accordingly, a retailer can use the report when generating an assortment strategy.

While an example manner of implementing the market research entity 102 of FIG. 1 is illustrated in FIG. 2, one or more of the elements, processes, and/or devices illustrated in FIG. 2 may be combined, divided, re-arranged, omitted, eliminated, and/or implemented in any other way. Further, the example ordering user interface circuitry 208, example order processor circuitry 216, example cross-channel analysis circuitry 218, example report generator circuitry 220, and/or, more generally, the market research entity 102 of FIG. 1, may be implemented by hardware alone or by hardware in combination with software and/or firmware. Thus, for example, any of the example ordering user interface circuitry 208, example order processor circuitry 216, example cross-channel analysis circuitry 218, example report generator circuitry 220, and/or, more generally, the example market research entity 102, could be implemented by processor circuitry, analog circuit(s), digital circuit(s), logic circuit(s), programmable processor(s), programmable microcontroller(s), graphics processing unit(s) (GPU(s)), digital signal processor(s) (DSP(s)), application specific integrated circuit(s) (ASIC(s)), programmable logic device(s) (PLD(s)), and/or field programmable logic device(s) (FPLD(s)) such as Field Programmable Gate Arrays (FPGAs). Further still, the example market research entity 102 of FIG. 1 may include one or more elements, processes, and/or devices in addition to, or instead of, those illustrated in FIG. 2, and/or may include more than one of any or all of the illustrated elements, processes and devices.

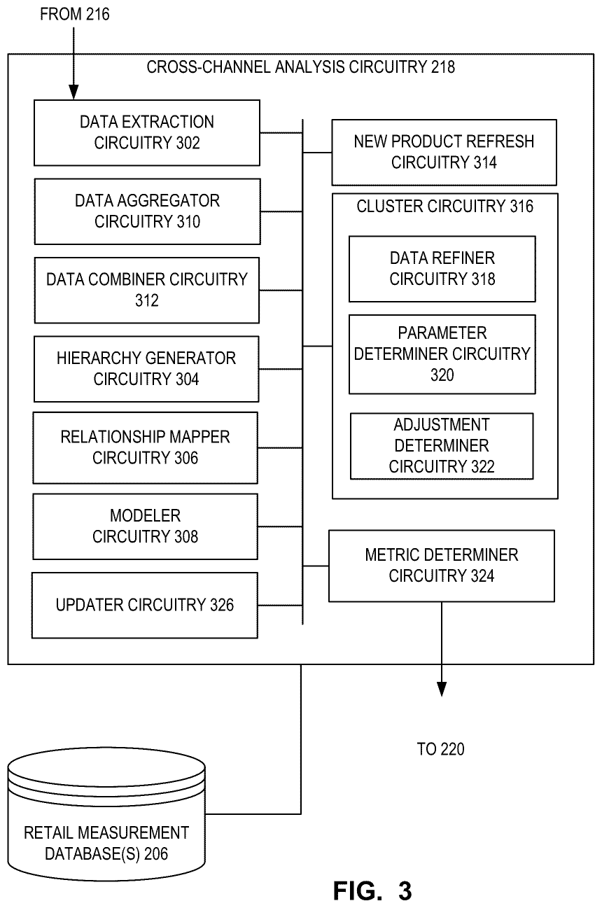

FIG. 3 is a block diagram of the example cross-channel analysis circuitry 218 constructed to determine a performance metric(s) for a new product(s) using cross-channel analysis techniques. The cross-channel analysis circuitry 218 of FIG. 3 may be instantiated (e.g., creating an instance of, bring into being for any length of time, materialize, implement, etc.) by processor circuitry such as a central processing unit executing instructions. Additionally or alternatively, the cross-channel analysis circuitry 218 of FIG. 3 may be instantiated (e.g., creating an instance of, bring into being for any length of time, materialize, implement, etc.) by an ASIC or an FPGA structured to perform operations corresponding to the instructions. It should be understood that some or all of the circuitry of FIG. 3 may, thus, be instantiated at the same or different times. Some or all of the circuitry may be instantiated, for example, in one or more threads executing concurrently on hardware and/or in series on hardware. Moreover, in some examples, some or all of the circuitry of FIG. 3 may be implemented by one or more virtual machines and/or containers executing on the microprocessor.

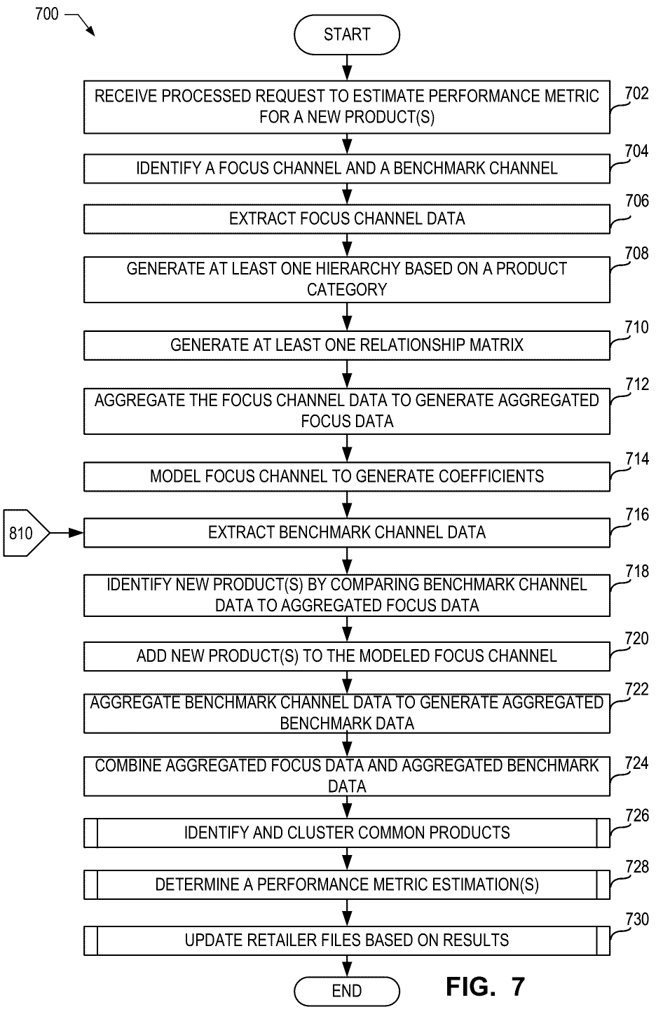

The cross-channel analysis circuitry 218 includes example data extraction circuitry 302, which is structured to retrieve (e.g., extract) data from the retail measurement database(s) 206 and/or another database(s). In some examples, the data extraction circuitry 302 is instantiated by processor circuitry executing data extraction instructions and/or configured to perform operations such as those represented by the flowchart of FIG. 7. The data extraction circuitry 302 may receive and/or retrieve the processed order data 210 from the order processor circuitry 216. Based on the processed order data 210, the data extraction circuitry 302 extracts corresponding data from the retail measurement database(s) 206 and/or another database.

In the example of FIG. 3, the data extraction circuitry 302 extracts first data corresponding to the focus channel (e.g., focus channel data) and second data corresponding to the benchmark channel (e.g., benchmark channel data). The first data and/or the second data can include data from primary dimensions of the retail measurement database 206. For example, the first data and/or the second data can include a market data that includes channel information related to retailer stores, a number of store(s) in operation, geographic information for the store(s), etc. The first data and/or the second data can also include products data that includes product specific attribute information such as, but not limited to product name, manufacturer name, brand, packaging type, product size, flavor, historical POS data, and/or a corresponding universal product code (UPC). In some examples, the products data includes time dimension information, such as indications of when a product was sold. In some examples, the products data includes fact dimension information, such as how much product was sold, value, value share, price, etc. In some examples, the products dataset includes all products belonging to a specific category. For example, the products data can include products corresponding to a category of a specific new product.

The data extraction circuitry 302 of FIG. 3 transmits the focus channel data to example hierarchy generator circuitry 304. In some examples, the data extraction circuitry 302 transmits the focus channel data to example data aggregator circuitry 310. The data extraction circuitry 302 of FIG. 3 transmits the benchmark channel data to example new product refresh circuitry 314. In some examples, the data extraction circuitry 302 transmits the benchmark channel data to the example data aggregator circuitry 310. In some examples, the data extraction circuitry 302 extracts additional or alternative data, such as pre-established hierarchies, assortment models, tables, etc.

The cross-channel analysis circuitry 218 includes example hierarchy generator circuitry 304, which is structured to generate a hierarchy (e.g., tree), such as a product hierarchy, attribute tree, etc. that segments products in the focus channel based on a category. In some examples, the example hierarchy generator circuitry 304 is instantiated by processor circuitry executing hierarchy generating instructions and/or configured to perform operations such as those represented by the flowchart of FIG. 7. The hierarchy generator circuitry 304 can receive the focus channel data and identify products sold in the focus channel that belong to a specific category. In some examples, the hierarchy generator circuitry 304 generates an attribute tree based on a pre-established product hierarchy stored in the retail measurement database 206 that segments products belonging to a channel. For example, the hierarchy generator circuitry 304 can generate a hierarchy by selecting a portion of a pre-established hierarchy associated with the focus channel.

In some examples, the hierarchy generator circuitry 304 generates a hierarchy by selecting a category of products (e.g., soft drinks, hair care, dental hygiene, etc.) and selecting levels of the hierarchy. The hierarchy generator circuitry 304 can then place products corresponding to the focus channel belonging to the category in respective nodes of the hierarchy. Typically, the lowest level of an attribute tree contains specific products. In some examples, the attribute tree enables visualization of products that are physically related. In some examples, an attribute tree can be used to map new products to a corresponding hierarchy of attributes.

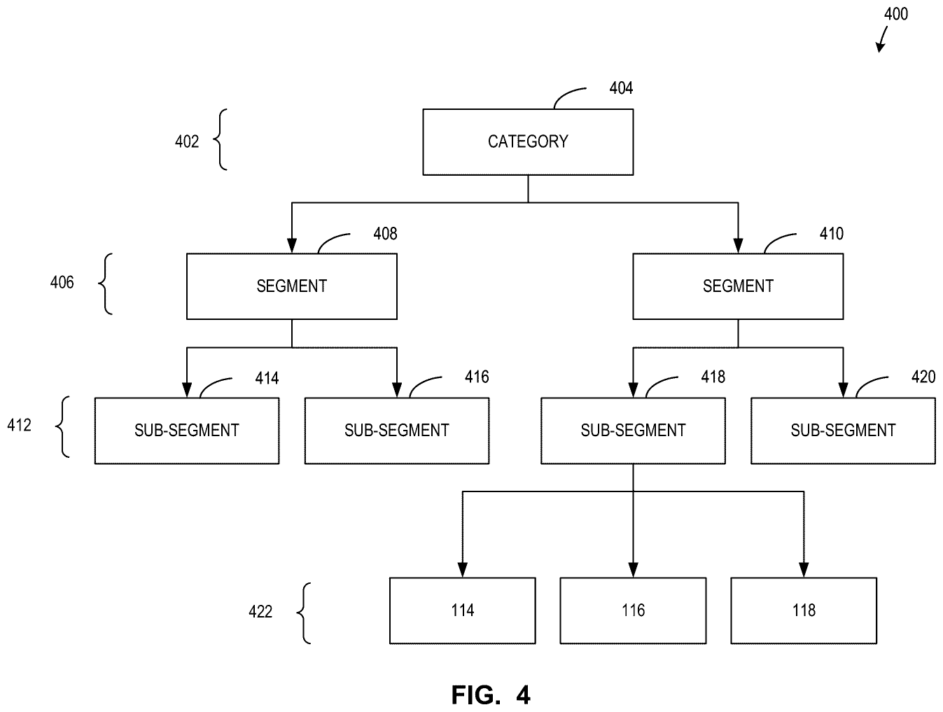

FIG. 4 illustrates an example hierarchy 400 structured in accordance with the teachings of this disclosure. In the illustrated example of FIG. 4, the example hierarchy 400 includes a first example level 402, which is the highest abstraction level of the hierarchy 400. In the illustrated example of FIG. 4, the first level 402 corresponds to an example category of products 404. For example, the category of products 404 can be soft drinks. However, the category of products 404 can be any category of products that corresponds to a new product or new category of products. The category of products 404 is the broadest level of the hierarchy 400. In the example of FIG. 4, the first level 402 includes nodes (e.g., segments, lower levels) having greater degrees of detail.

The products hierarchy 400 includes an example second level 406 that includes a greater level of granularity than the first level 402. The second level 406 of FIG. 4 includes an example first segment 408 (e.g., diet soft drinks) and an example second segment 410 (e.g., regular soft drinks). In some examples, the second level 406 can include more than two segments. For example, an example third segment could include “zero” soft drinks. Each node in the hierarchy 400 includes all of the nodes below it. Accordingly, the category includes the nodes corresponding to the segments 408, 410.

The hierarchy 400 of FIG. 4 includes an example third level 412 that further partitions the segments 408, 410 of the second level 406, providing a greater level of granularity. For example, the segment 408 (e.g., diet soft drinks) includes an example first sub-segment 414 (e.g., a first brand) and an example second sub-segment 416 (e.g., a second brand). Similarly, the segment 410 (e.g., regular soft drinks) can include an example third sub-segment 418 (e.g., the first brand) and an example fourth sub-segment 420 (e.g., the second brand). Each segment 408, 410 includes all of the nodes below it (e.g., respective sub-segments 414, 416, 418, 420).

The hierarchy 400 of FIG. 4 includes an example fourth level 422. In the illustrated example of FIG. 4, the fourth level 422 is the most granular level. However, the hierarchy 400 can include more or less levels in additional or alternative examples. In the illustrated in FIG. 4, the fourth level 422 is the lowest abstraction level and, thus, includes products. For example, the sub-segment 418 can include products belonging to the node. For example, the sub-segment 418 of FIG. 4 can include product A 114, product B 116, and/or product X 118 of FIG. 1. It is understood that the lowest level of an attribute tree can include any number of products (e.g., for which data exists or can be estimated).

In some examples, each node within the hierarchy 400 is associated with data, such as product attributes, sales data, price, distribution, etc. Accordingly, information about a product can be obtained by selecting the product in the hierarchy 400. Further, information about a category, a segment, a sub-segment, etc. can be obtained by selecting a corresponding node in the hierarchy 400.

Referring again to FIG. 3, the cross-channel analysis circuitry 218 includes example relationship mapper circuitry 306, which is structured to generate and/or select one or more mapping structures, such as a matrix, table, etc. In some examples, the relationship mapper circuitry 306 is instantiated by processor circuitry executing mapping instructions and/or configured to perform operations such as those represented by the flowchart of FIG. 7.

A relationship matrix can include rows, columns, and cells at the intersections of the rows and columns that include data, such as the differential weights. For example, the rows can include products and the columns can include the same products. Because products have a direct impact on themselves, products along the diagonal of the relationship matrix reflect a direct impact (e.g., an impact of the product on itself). Products not along the diagonal reflect a cross impact, which include performance coefficients and product attributes at the product level to allow one or more calculations of the effect on one product to another product when added to an assortment. To identify an effect that changing an assortment of products may have on sales, the product pairs may be selected at different rows and columns to calculate impact parameters from the intersecting cell coefficient value(s).

Typically, different geographies behave different in terms of consumer behavior. In the U.S., for example, a retailer in a Northern region is likely to sell more winter jackets than a retailer in a Southern region because of differences in weather. In some examples, different hierarchies are generated for different geographic regions of interest to reflect particular regional differences. In additional or alternative examples, differential weights may have been derived between products of one or more categories and/or specific to one or more channels or geographies to account for such differences. In some such examples, the differential weights can be used by the relationship mapper circuitry 306 to generate one or more relationship matrices. For example, a relationship matrix can tailored to include geographic attributes that reflect interaction behavior for particular geographic regions within a channel. Changing geographic regions exhibit different impacts from one product to another product, different impacts from one product to a category of products, different proportions of sales, etc. As such, the relationship matrix illustrates how products give and/or take away volume when introduced on a retail shelf in a given geographic market, which may be further influenced by the geographic attributes, such as, but not limited to distribution measures, product attributes, channel placement, etc. In some examples, the relationship mapper circuitry 306 generates a relationship matrix that corresponds to a hierarchy or hierarchies generated by the hierarchy generator circuitry 304.

The cross-channel analysis circuitry 218 includes example modeler circuitry 308, which is structured model at least a portion of an assortment for the focus channel. Examples disclosed herein do not model the benchmark channel for the prediction of the new product for the focus channel (e.g., unless the benchmark channel becomes the focus channel). In some examples, the modeler circuitry 308 is instantiated by processor circuitry executing metric modeling instructions and/or configured to perform operations such as those represented by the flowchart of FIG. 7.

The modeler circuitry 308 can use any suitable technique to model the focus market. In some examples, the modeler circuitry 308 models the focus channel assortment based on a single hierarchy. For example, the modeler circuitry 308 can receive the focus channel data from the data extraction circuitry 302, which includes to an assortment of products that is to be modeled. The modeler circuitry 308 can receive the at least one hierarchy from by the hierarchy generator circuitry 304 and the at least one relationship matrix generated from the relationship mapper circuitry 306. The modeler circuitry 308 can then calculate categorical impact coefficients for each of the products and their associated categories in the hierarchy. For example, each product in the hierarchy can be weighted (e.g. using sales data) to establish an impact score (e.g., parameter, coefficient, etc.). In some examples, the impact coefficients are calculated using historical sales data for each of the products in their respective categories and subcategories. An average impact score can then be calculated across all products in the hierarchy. If an individual impact score is less than the average impact score, the product is deemed to have a low impact on the given sub-category. If the individual, impact score is greater than the average impact score, the product is deemed to have a high impact on the given sub-category. In some examples, the modeler circuitry 308 generates a model based on multiple product hierarchies to generate a reportable segmentation. For example, the hierarchy generating circuitry 304 can generate multiple hierarchies based on the product category, with each hierarchy representing a different viewpoint. The modeler circuitry 308 can then generate blended hierarchies using based on the multiple hierarchies generated by the hierarchy generating circuitry 304.

The cross channel analysis circuitry 218 includes example data aggregator circuitry 310, which is structured to aggregate extracted and/or processed data. In some examples, the data aggregator circuitry 310 is instantiated by processor circuitry executing data aggregator instructions and/or configured to perform operations such as those represented by the flowchart of FIG. 7. As disclosed herein, data aggregation refers to a process of expressing gathered data in a summary form. The data aggregator circuitry 310 receives data from other components of the cross-channel analysis circuitry 218, processes the data, and outputs an aggregated dataset. The data aggregator circuitry 310 of FIG. 3 receives focus channel data from the data extracting circuitry 302, a product hierarchy (e.g., from the hierarchy generator circuitry 304) and/or a relationship matrix (e.g., from the relationship mapper circuitry 306) and aggregates the data into example aggregated focus data. For example, the aggregated focus data can include summary statistics for products within the focus channel belonging to a specific category. In some examples, the aggregated focus data is in the form of a table that includes rows products and columns of attributes corresponding to the products. In some such examples, the aggregated focus data can include hundreds to thousands of rows and hundreds to thousands of columns. However, the aggregated focus data can be in other formats with different levels of granularity in additional or alternative examples. In some examples, the data aggregator circuitry 310 transmits the aggregated focus data to example data combiner circuitry 312.

In some examples, the data aggregator circuitry 310 of FIG. 3 receives benchmark channel data from the data extracting circuitry 302 and other benchmark related data from other components of the cross-channel analysis circuitry 218 and aggregates the data to generate example aggregated benchmark data (described in further detailed below).

The cross channel analysis circuitry 218 includes the example data combiner circuitry 312, which is structured to combine (e.g., merge) datasets. In some examples, the data combiner circuitry 312 is instantiated by processor circuitry executing combining instructions and/or configured to perform operations such as those represented by the flowchart of FIG. 7. The data combiner circuitry 312 of FIG. 3 receives the aggregated focus data (e.g., from the data aggregator circuitry 310) and the focus model (e.g., from the modeler circuitry 308) and combines the data based on related fields. For example, if the aggregated focus data is in the form of a table organized based on products, the focus model data can be added to the table. For example, columns can be added to the aggregated focus data table and the focus model data can be added into cells of the new columns. However, datasets can be combined using additional or alternative methods in other examples. In some examples, the method of combining data sets is based on a form of the data (e.g., a table, a matrix, a tree, etc.).

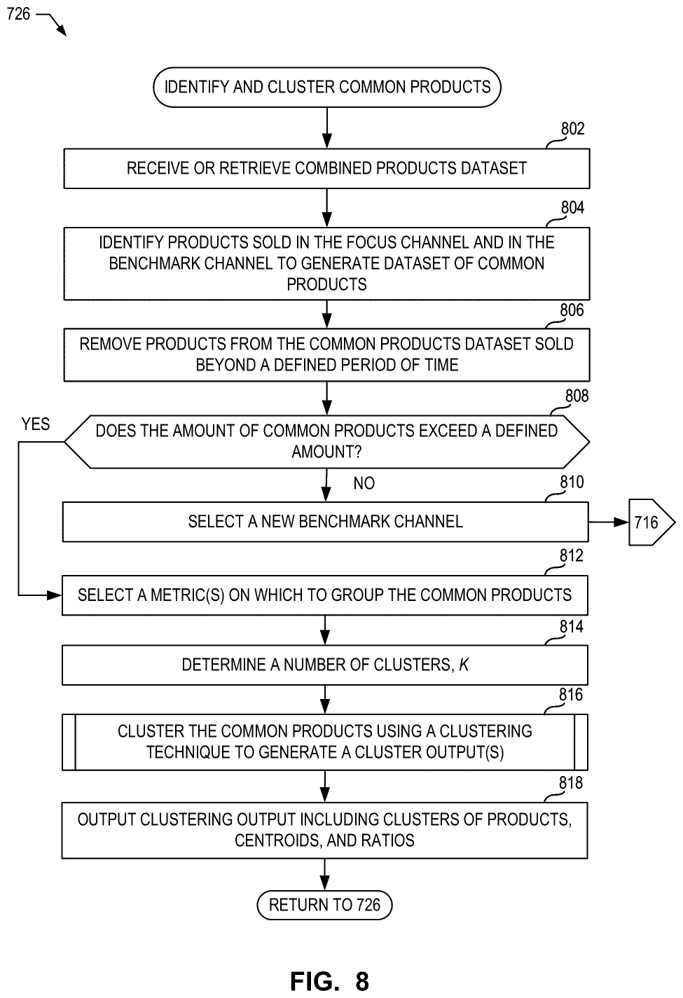

The cross channel analysis circuitry 218 includes example new product refresh circuitry 314, which is structured to identify a new product(s) and add the new product(s) to a model(s), hierarchy(ies), and/or a dataset(s) within the cross-channel analysis circuitry 218. In some examples, the new product refresh circuitry 314 is instantiated by processor circuitry executing new product refresh instructions and/or configured to perform operations such as those represented by the flowcharts of FIGS. 7-8.

The new product refresh circuitry 314 of FIG. 3 receives or otherwise retrieves the extracted benchmark channel data (e.g., from the data extraction circuitry 302) and the combined focus data. In some examples, the new product refresh circuitry 314 identifies a product(s) selling in the benchmark channel, but not in the focus channel. For example, the new product refresh circuitry 314 can identify the new product(s) by comparing the benchmark channel data (e.g., which can include hundreds to millions of products) to the combined focus data (which can include hundreds to millions of products) to identify products corresponding to a specific category that are in the benchmark channel data, but not in the combined focus data.

In some examples, the new product refresh circuitry 314 adds the new products into the focus channel hierarchy(ies). For example, the new product refresh circuitry 314 can identify a spatial location within a hierarchy generated by the hierarchy generator circuitry 304 in which to place the new product. In some examples, the new product refresh circuitry 314 adds the new product to a relationship matrix generated by the relationship mapper circuitry 306. For example, the new product refresh circuitry 314 can incorporate the new product into a new product row and a new product column based on the addition of the new product to the hierarchy(ies), geographic information, and/or other information. In some examples, the new product refresh circuitry 328 generates proxy coefficients, such as a Q coefficient or an autoregression (AR) coefficient. An autoregressive (AR) model predicts future behavior based on past behavior. Thus, in some examples, the new product refresh circuitry 314 adds the new product to the focus model.

In some examples, the new product refresh circuitry 314 transmits the new product information to the data aggregator circuitry 310 to be aggregated with the benchmark channel data. For example, the data aggregator circuitry 310 can aggregate the benchmark channel data received from the data extraction circuitry 302 and the new product(s) from the new product refresh circuitry 314 to generate aggregated benchmark data. In some examples, the aggregated benchmark data is limited to product level information and is associated with a market identifier (ID) as selected by the market participants requester. For example, the benchmark channel can include data from retailers that are distinct from the market participant requester. Thus, to maintain privacy of retailers or other data providers, the benchmark channel data provided to the market participant requester can be minimal.

In some examples, the data aggregator circuitry 310 transmits the aggregated benchmark data to the data combiner circuitry 312 to be combined with the aggregated focus data. For example, the aggregated focus data can be combined with the aggregated benchmark data to generate an example combined products dataset that can be used for the clustering process. In some examples, the data combiner circuitry 312 adds the aggregated benchmark data to rows of an aggerated focus data table (e.g., as opposed to columns of the table). In some examples, the combined products dataset can include thousands of products, with each products having hundreds to thousands of characteristics, data, attributes, etc. In some examples, the data combiner circuitry 312 transmits the combined products dataset to example cluster circuitry 316.

The cross channel analysis circuitry 218 includes example cluster circuitry 316, which is structured to cluster products that are similar based on at least one metric. In some examples, the cluster circuitry 316 is instantiated by processor circuitry executing clustering instructions and/or configured to perform operations such as those represented by the flowcharts of FIGS. 7-9. As noted above, clustering alike products facilitates identification of products selling in both the focus channel and the benchmark channel that are similar to and/or different from a new product to narrow down a number of products by group to be used as proxies to estimate a performance metric (e.g., ROS, etc.) and elasticities. Thus, clustering products that are similar to a new product(s) enables a better estimation of sales in the focus channel based on the information for the like products that are selling in both channels.

The example cluster circuitry 316 includes example data refiner circuitry 318, which is structured to generate a dataset for which to apply a clustering technique. In some examples, the data refiner circuitry 318 is instantiated by processor circuitry executing refining instructions and/or configured to perform operations such as those represented by the flowchart of FIG. 8. The data refiner circuitry 318 receives or otherwise retrieves the combined products dataset from the data combiner circuitry 312. The data refiner circuitry 318 identifies time data associated with the products. For example, the data refiner circuitry 318 determines the newest date in which a product has sales data. In some examples, the data refiner circuitry 318 removes products from the combined products dataset that were last sold beyond a specific historical date so that the clustering techniques are applied only to recently sold products. For example, the data refiner circuitry 318 may remove products from the combined products dataset that are associated with a sales date beyond a specific date and/or beyond a threshold period of time (e.g., a week(s), a month(s), a quarter(s), etc.).

In some examples, the data refiner circuitry 318 identifies products selling in both the focus channel and the benchmark. For example, only products that are sold in the focus channel and in benchmark channel (e.g., common products) are grouped into clusters (e.g., product clusters). Thus, the data refiner circuitry 318 identifies products within the combined dataset having hundreds to thousands of products that are sold in both the benchmark channel and the focus channel. In some examples, if the data refiner circuitry 318 determines that a number of common products is below a certain threshold, then no products from the benchmark channel are added to the focus channel model. In some such examples, the cross-channel analysis circuitry 218 determines to select a new benchmark channel and begins the process again. In some examples, the cross-channel analysis circuitry 218 requests a new benchmark channel from the market participant requester. However, the cross-channel analysis circuitry 218 can respond in other manners in additional or alternative examples. For example, the cross-channel analysis circuitry 218 may alert the market participant requester than the performance metric cannot be determined for the requested geographies. In some such examples, the market participant requester may need to submit a new request via the ordering user interface circuitry 208 of FIG. 2.

The data refiner circuitry 318 generates a refined products dataset that includes common products between the focus channel and the benchmark channel that are associated with relatively recent sales data. In some examples, the refined products dataset can include at least hundreds to thousands of products. However, the refined products dataset can include more or less products in additional or alternative examples. In some examples, the refined products dataset includes products that will be used in the clustering process. In some examples, the refined products dataset includes products from which sales data can be used to predict a performance metric for the new product(s).

The cluster circuitry 316 includes example parameter determiner circuitry 320, which is structured to determine (e.g., select, choose, etc.) parameters to be used during the clustering process. In some examples, the parameter determiner circuitry 320 selects one or more metrics on which to cluster the common products. In some examples, the selected metrics are used to define a new product. In some examples, the selected metrics are used to group products that are similar in a high level view. Example metrics can include price, velocity, distribution, promotional or standard, size or format, manufacturer versus private label, etc. In some examples, the parameter determiner circuitry 320 determines to cluster the common products based on a price metric, an ROS metric, a distribution metric, a format metric, and a sensitivity flag metric.

In some examples, the parameter determiner circuitry 320 adds a flag (e.g., a tag, etc.) to products within the refined products dataset. For example, the parameter determiner circuitry 320 can add a promotion flag to a product that was sold less than a whole period or only within certain weeks. For example, the parameter determiner circuitry 320 can identify products that appear, disappear, and re-appear during, for example, a year. In some examples, the parameter determiner circuitry 320 applies a seasonality flag to one or more products in the refined products dataset. For example, the seasonality flag can be added by analyzing a variation in sales across a whole period. If there was some variation above a certain threshold, a flag would be active (e.g., a coefficient of variation could be used).

In some examples, the cluster circuitry 316 is structured to generate clusters of the common products based on the selected metrics. For example, the cluster circuitry 316 can apply a clustering technique to create groups of products that are alike based on the selected metrics. The cluster circuitry 316 of FIG. 3 applies a k-means clustering technique in which k clusters are generated. However, other clustering techniques can be used in additional or alternative examples. K-mean clustering is an algorithm that can be useful for identifying possible groups of alike data within large data sets having many features. K-means clustering can be useful in a clear manner of segmenting the data is unknown. Accordingly, k-means clustering can be used to understand massive sets of data with a large number of features by finding groups of interest.

In some examples, the parameter determiner circuitry 320 of FIG. 3 determines a number of clusters, k, to in which to cluster the common products. That is, the number of clusters, k, corresponds to a number of clusters to generate during the clustering process. In some examples, the parameter determiner circuitry 320 utilizes an elbow method to select the number of clusters. The elbow method is a technique used to determine an optimal or otherwise suitable number of clusters into which a dataset may be clustered. The elbow method includes executing the clustering process for different values of k (e.g., by varying k from 1 to 10 clusters). For example, the cluster circuitry 316 can run the clustering process, described in further detail below, for a plurality of k values (e.g., from 1 to 10). The parameter determiner circuitry 320 can then calculate, for example, the total within-cluster sum of square (WSS) for each k and plot a curve of WSS according to the number of clusters k. The parameter determiner circuitry 320 can identify a location of a bend (e.g., elbow, knee, etc.) in the plot and select a k corresponding to the elbow point.

In some examples, the parameter determiner circuitry 320 utilizes a silhouette method to evaluate a number of clusters. The silhouette method is a technique use to interpret and consistency within clusters of data. For example, the cluster circuitry 316 can run the clustering process for different values of k and the parameter determiner circuitry 320 can, for each k, calculate the average silhouette of observations. The parameter determiner circuitry 320 can plot a curve of the average silhouette of observations according to the number of clusters k. The parameter determiner circuitry 320 can determine a value of k by identifying a location of the maximum.

In other words, to determine a number of clusters, k, the cluster circuitry 316 can apply the clustering process to a refined products dataset having at least hundreds to thousands of products based on multiple metrics, numerous times. The parameter determiner circuitry 320 can analyze the results (e.g., using the elbow method, silhouette method, and/or another method) to determine a number of clusters that produces useful results. In some examples, the parameter determiner circuitry 320 transmits the selected metrics and the determined number of clusters, k, to example cluster circuitry 316. In some examples, the parameter determiner circuitry 320 analyzes the results of the elbow method and/or the silhouette method to determine which metrics produce the largest impact in the groupings. For example, the parameter determiner circuitry 320 can compare the parameters produced by the elbow and/or silhouette methods when using only a price metric, only an ROS metric, price and ROS metrics, etc.

The cluster circuitry 316 of FIG. 3 initializes the clustering process by selecting k points to be initial centroids. The initial centroids can be randomly selected or selected based on an evaluation. The cluster circuitry 316 assigns each of the common products to a centroid (e.g., to a cluster) based on the selected metrics and respective data for each of the common products. A point corresponding to a common product is considered to belong to a particular cluster if the point is closer to that cluster's centroid than any other centroid. The cluster circuitry 316 of FIG. 3 assigns the common products to the clusters based on the benchmark channel data. When each of the common products are assigned to a cluster, the cluster circuitry 316 re-computes the centroids based on the formed clusters. For example, the cluster circuitry 316 re-computes the centroids by calculating a mean of all points corresponding to common products with each cluster.

Once the centroids are re-computed, the cluster circuitry 316 of FIG. 3 assigns each of the common products to the newly determined centroids (e.g., based on the selected metrics and respective data for each of the common products) to form new clusters. The cluster circuitry 316 then re-computes the centroids based on newly formed clusters. After each clustering iteration, new centroids are determined based on newly formed clusters. In some examples, the cluster circuitry 316 re-assigns the common products to the re-computed centroids. In some examples, this iteration continues until a stopping criterion is reached. An example stopping criterion can be a defined number of iterations completed. For example, if the defined number of iterations is 20, the cluster circuitry 316 iterates the clustering process for 20 iterations or until another stopping criterion is met.

Another example stopping criterion can be stabilization of the centroids. In some examples, after each iteration, the cluster circuitry 316 compares a new centroid to the previous centroid to determine whether the new centroid moved. If the new centroid did not move compared to the previous centroid, or the new centroid moved less than a threshold distance from the previous centroid, the cluster circuitry 316 may determine that the clusters are stabilized. In some examples, a stopping criterion can correspond to cluster variation within the common products. For example, the cluster variation can correspond to a sum of Euclidean distances between the data points (e.g., corresponding to the common products) and their respective cluster centroids. In some examples, additional or alternative stopping criteria can be applied by the cluster circuitry 316.

When the cluster circuitry 316 identifies a stopping criterion, the cluster circuitry 316 stops the clustering process. In some examples, the cluster circuitry 316 outputs a clustering output that includes the latest centroids corresponding to the selected metrics around which are data points representing the common products assigned to each of the clusters.

In some examples, the cluster circuitry 316 adds the new product(s) to the clustering output. For example, the cluster circuitry 316 can add the new product(s) to the clustering output based on the selected metrics and benchmark data for the new product(s). In some examples, the cluster circuitry 316 determines a distance of each centroid corresponding to a cluster to the new product(s). In some examples, the ratio of sales is used to scale up the benchmark data or scale down the benchmark data. In some examples, the cluster circuitry 316 uses the distance of each centroid corresponding to a cluster to the new product(s) to determine inverse squared distances for each cluster. In some examples, the inverse squared distances are used to apply a weight to the ratio of sales for a cluster. As such, a cluster that is closer to the new products and, thus, more similar to the new products can receive a higher weight than a product that is further away from the new product.

The cluster circuitry 316 includes example adjustment determiner circuitry 322, which is structured to determine a ratio of sales of the focus channel to the benchmark channel for at least one generated cluster. For example, the adjustment determiner circuitry 322 can select a first cluster to determine a ratio of sales. In some examples, the adjustment determiner circuitry 322 identifies each product in the first cluster and uses data associated with the identified products in the first cluster (e.g., using the combined products dataset) to determine the ratio of sales. For example, the adjustment determining circuitry 322 can add ROSs for the products in the first cluster for the focus channel (e.g., ROS_{focus}) and the ROSs for the products in the first cluster for the benchmark channel (e.g., ROS_{benchmark}). In some examples, the adjustment determiner circuitry 322 adjusts each ratio of sales by multiplying a ratio of sales of a corresponding cluster by a respective inverse squared distance.

In some examples, the cluster circuitry 316 outputs a first table (e.g., a cluster definition table) that provides products making up each cluster by combination of retailers (e.g., focus channel retailers and benchmark channel retailers). In some examples, the cluster circuitry 316 outputs a second table (e.g., a cluster assignment table) that assigns a cluster to work for each product by combination of retailers (e.g., focus channel retailers and benchmark channel retailers). The first table and the second table contain the products sold in the benchmark channel. In some examples, the tables includes products belonging to the focus channel and the benchmark channel, as well as products only selling in the benchmark channel. In some such examples, information related to products sold in the benchmark channel only includes a market identifier (ID) for the benchmark channel as selected by the requester to maintain privacy of the benchmark channel.

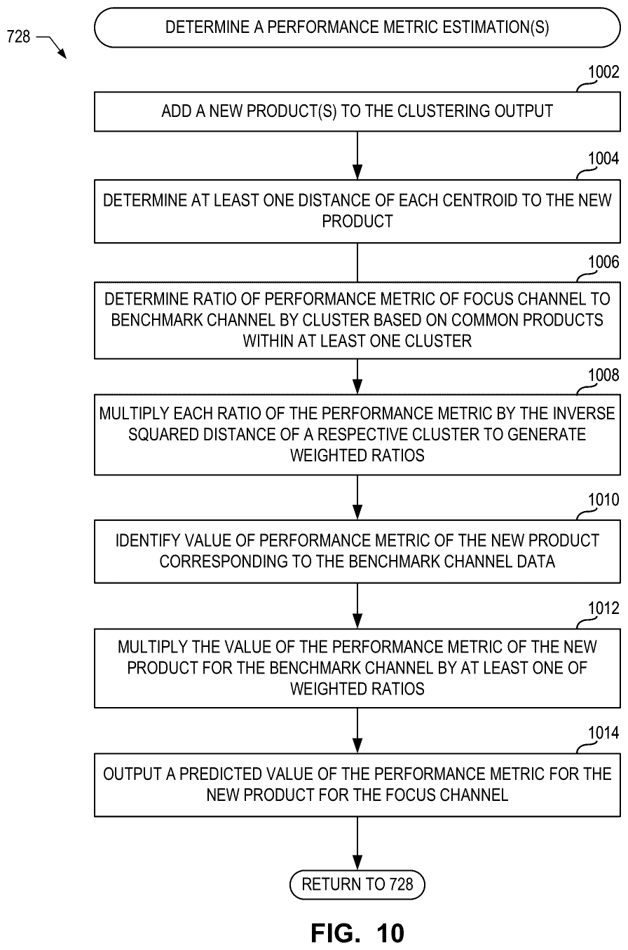

The cross channel analysis circuitry 218 includes example metric determiner circuitry 324, which is structured to calculate a performance metric(s) for a new product(s). In some examples, the metric determiner circuitry 324 is instantiated by processor circuitry executing clustering instructions and/or configured to perform operations such as those represented by the flowcharts of FIG. 10. In some examples, the metric determiner circuitry 324 determines a ROS for the new product. However, the metric determiner circuitry 324 can calculate additional or alternative metrics. In some examples, the metric determiner circuitry 324 determines the ROS for the new products for the focus channel based on the data for the new product from the aggregated benchmark data. The metric determiner circuitry 324 can determine the ROS for the new product for the focus channel by multiplying the ROS for the new product from the benchmark channel by the sales ratio or adjusted sales ratio.

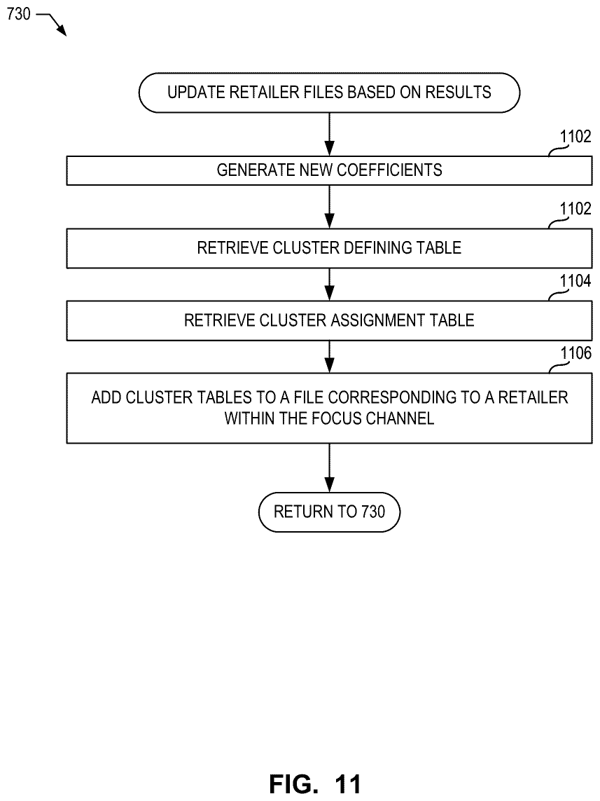

The cross channel analysis circuitry 218 includes example updater circuitry 326, which is structured to update other components of a workflow. In some examples, the updater circuitry 326 is instantiated by processor circuitry executing updating instructions and/or configured to perform operations such as those represented by the flowcharts of FIG. 11. In some examples, the market research entity 102 executes a plurality of simulations for market participants. For example, the market research entity 102 may execute an application as a service in which market participants can make requests for data, view data, run simulations, etc. In some such examples, the updater circuitry 326 updates a market participant's profile with outputs generated by the cross-channel analysis circuitry 218. In some examples, the updater circuitry 326 updates assortment and space optimization (ASO) tables corresponding to the market participant requester. In some examples, the updater circuitry 326 uploads the first table, second table, new product information, clustering output, clustering data, combined products dataset, etc. to the market participant's profile.

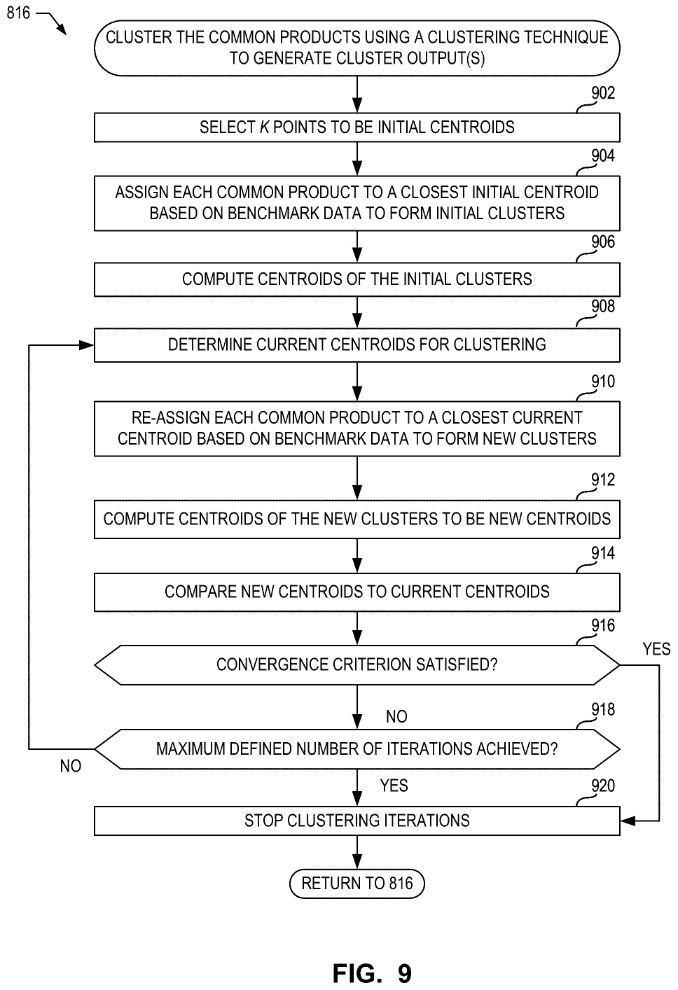

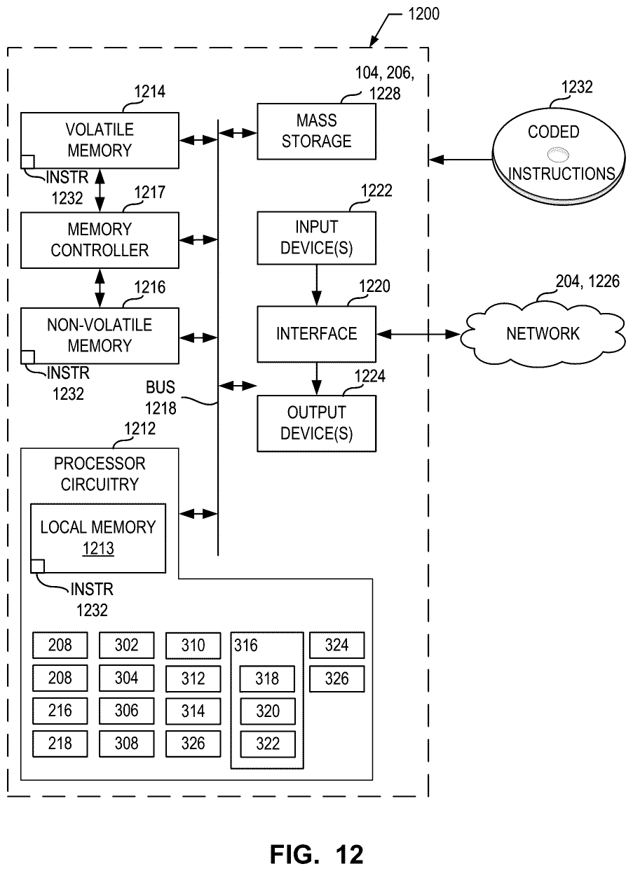

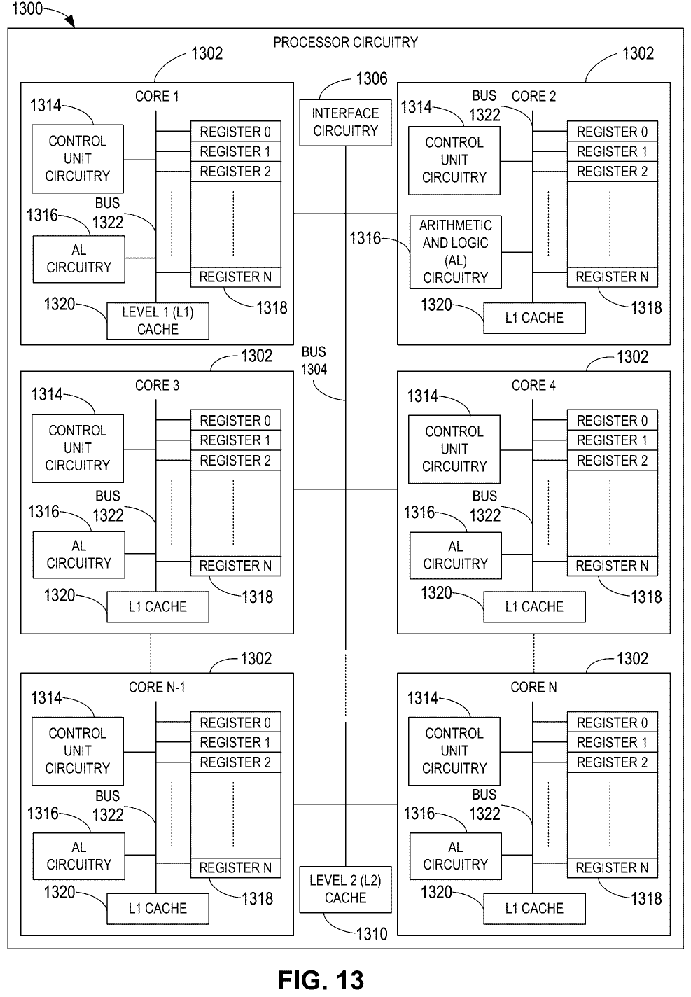

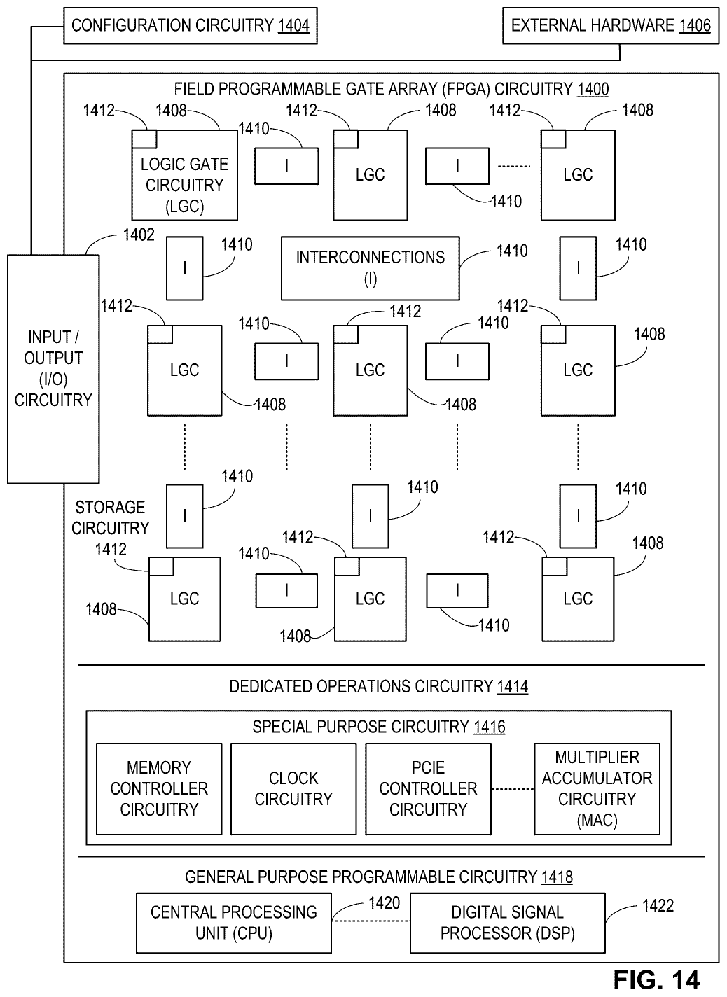

In some examples, the cross-channel analysis circuitry 218 includes means for clustering common products based on selected metrics. For example, the means for clustering may be implemented by example cluster circuitry 316. In some examples, the cluster circuitry 316 may be instantiated by processor circuitry such as the example processor circuitry 1212 of FIG. 12. For instance, the cluster circuitry 316 may be instantiated by the example microprocessor 1300 of FIG. 13 executing machine executable instructions such as those implemented by at least blocks 726 of FIG. 7 and 816 of FIGS. 8-9. In some examples, the cluster circuitry 316 may be instantiated by hardware logic circuitry, which may be implemented by an ASIC, XPU, or the FPGA circuitry 1400 of FIG. 14 structured to perform operations corresponding to the machine readable instructions. Additionally or alternatively, the cluster circuitry 316 may be instantiated by any other combination of hardware, software, and/or firmware. For example, the cluster circuitry 316 may be implemented by at least one or more hardware circuits (e.g., processor circuitry, discrete and/or integrated analog and/or digital circuitry, an FPGA, an ASIC, XPU, a comparator, an operational-amplifier (op-amp), a logic circuit, etc.) structured to execute some or all of the machine readable instructions and/or to perform some or all of the operations corresponding to the machine readable instructions without executing software or firmware, but other structures are likewise appropriate.

While an example manner of implementing the cross-channel analysis circuitry 218 of FIG. 2 is illustrated in FIG. 3, one or more of the elements, processes, and/or devices illustrated in FIG. 3 may be combined, divided, re-arranged, omitted, eliminated, and/or implemented in any other way. Further, the example data extraction circuitry 302, example hierarchy generator circuitry 304, example relationship mapper circuitry 306, example modeler circuitry 308, example data aggregator circuitry 310, example data combiner circuitry 312, example new product refresh circuitry 314, example cluster circuitry 316, example data refiner circuitry 318, example parameter determiner circuitry 320, example adjustment determiner circuitry 322, example metric determiner circuitry 324, example updater circuitry 326, and/or, more generally, the example cross-channel analysis circuitry 218 of FIG. 2, may be implemented by hardware alone or by hardware in combination with software and/or firmware. Thus, for example, any of the example data extraction circuitry 302, example hierarchy generator circuitry 304, example relationship mapper circuitry 306, example modeler circuitry 308, example data aggregator circuitry 310, example data combiner circuitry 312, example new product refresh circuitry 314, example cluster circuitry 316, example data refiner circuitry 318, example parameter determiner circuitry 320, example adjustment determiner circuitry 322, example metric determiner circuitry 324, example updater circuitry 326, and/or, more generally, the example cross-channel analysis circuitry 218, could be implemented by processor circuitry, analog circuit(s), digital circuit(s), logic circuit(s), programmable processor(s), programmable microcontroller(s), graphics processing unit(s) (GPU(s)), digital signal processor(s) (DSP(s)), application specific integrated circuit(s) (ASIC(s)), programmable logic device(s) (PLD(s)), and/or field programmable logic device(s) (FPLD(s)) such as Field Programmable Gate Arrays (FPGAs). Further still, the example cross-channel analysis circuitry 218 of FIG. 2 may include one or more elements, processes, and/or devices in addition to, or instead of, those illustrated in FIG. 3, and/or may include more than one of any or all of the illustrated elements, processes and devices.

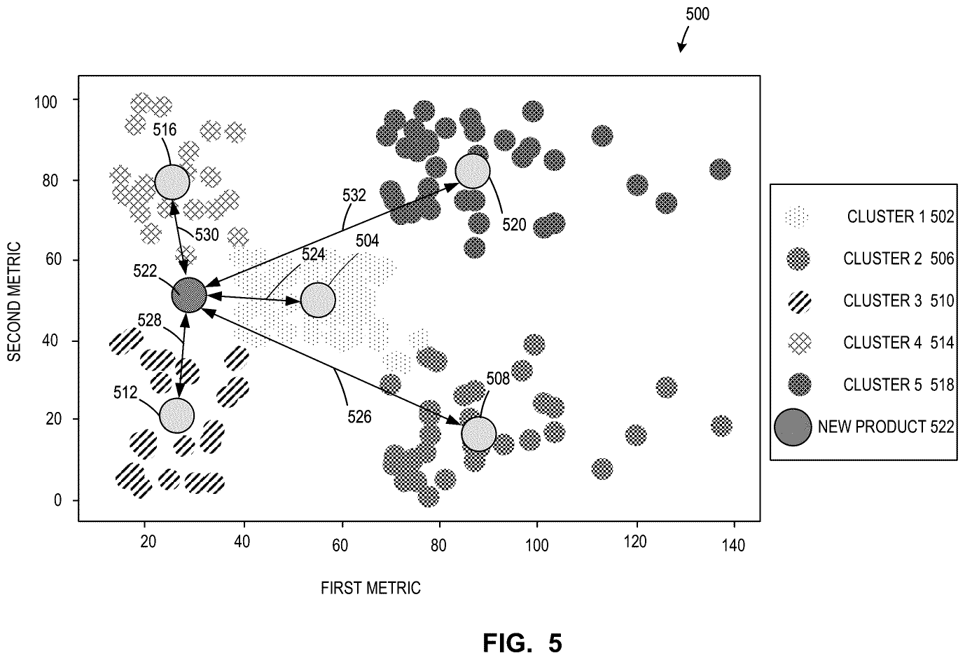

FIG. 5 is a schematic illustration of an example clustering output 500 in accordance with the teachings of this disclosure. The clustering output 500 includes an example first cluster 502, which can correspond to a first group of products that are similar to each other based on a first metric. The first cluster 502 includes an example first centroid 504, which is a center of the cluster determine by taking an average of each point corresponding to a product within the cluster. The clustering output 500 includes an example second cluster 506, which can correspond to a second group of products that are similar to each other based on a second metric. The second cluster 506 includes an example second centroid 508, which is a center of the second cluster 506 of alike products.

The clustering output 500 includes an example third cluster 510, which can correspond to a third group of products that are similar to each other based on a third metric. The third cluster 510 includes an example third centroid 512, which is a center of the third cluster 510. The clustering output 500 includes an example fourth cluster 514, which can correspond to a fourth group of products that are similar to each other based on a fourth metric. The fourth cluster 514 includes an example fourth centroid 516, which is a center of the fourth cluster 514. The clustering output 500 includes an example fifth cluster 518, which can correspond to a fifth group of products that are similar to each other based on a fifth metric. The fifth cluster 518 includes an example fifth centroid 520, which is a center of the fifth cluster 518.

The clustering output 500 of FIG. 5 includes an example new product 522, which can correspond to a product sold in a benchmark channel, but not in a focus channel. The new product 522 is positioned in a clustering output based on the metrics and based on the benchmark data. Each centroid 504, 508, 512, 516, 520 is a measured distance away from the new product. For example, the first centroid 504 is a first distance 524 away from the new product 522, the second centroid 508 is a second distance 526 away from the new product 522, the third centroid 512 is a third distance 528 away from the new product 522, the fourth centroid 516 is a fourth distance 530 away from the new product 522, and the fifth centroid 520 is a fifth distance 532 away from the new product 522. In some examples, the clusters 502, 506, 510, 514, 518 are weighted by a respective inverse squared distance 524, 526, 528, 530, 532.

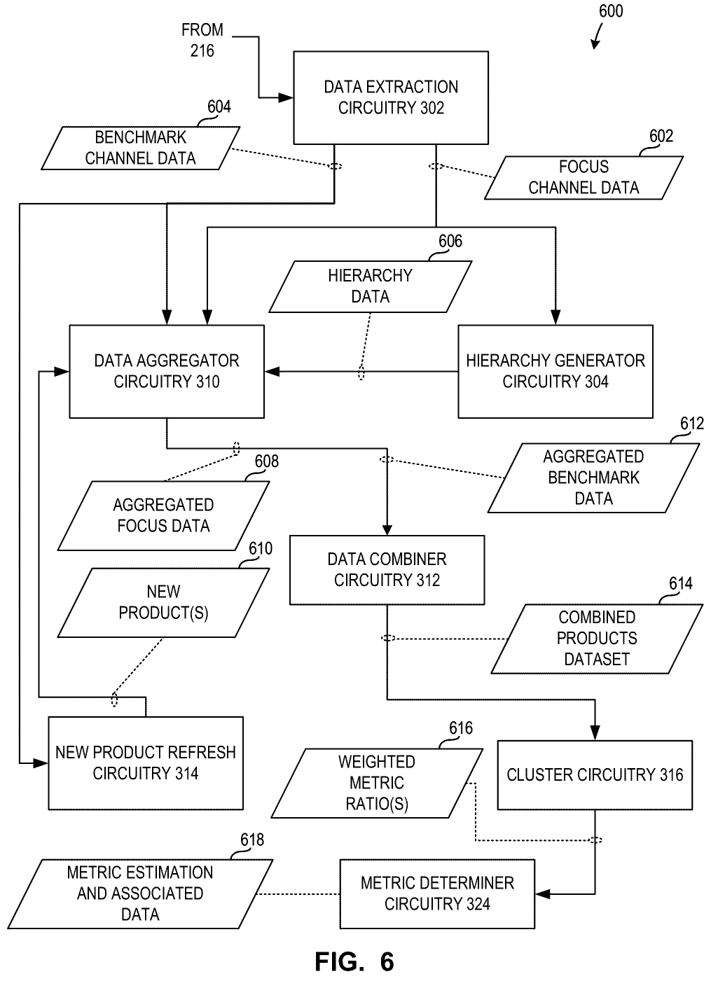

FIG. 6 is a block diagram of an example implementation of the example cross-channel analysis circuitry 218 of FIGS. 2 and 3. Upon receiving order information from the order processor circuitry 216 of FIG. 3, the example data extraction circuitry 302 extracts focus channel data 602 and example benchmark channel data (e.g., from example retail measurement database 206 of FIGS. 2-3). The data extraction circuitry 302 transmits the focus channel data 602 to example hierarchy generator circuitry 304 and to the example data aggregator circuitry 310. Further, the data extraction circuitry 302 transmits the benchmark channel data 604 to example data aggregator circuitry 310 and to the example new products refresh circuitry 314.

The hierarchy generator circuitry 304 uses the focus channel data 602 to generate at least one attribute tree based on a category of products (e.g., corresponding to a new product or category of new products). Each product in the attribute tree includes details for the product, such as UPC, price, sales data, etc. The hierarchy generator circuitry 304 transmits example hierarchy data 606, which includes the hierarchy and associated data, to the data aggregator circuitry 310.

The data aggregator circuitry 310 of FIG. 6 aggregates the focus channel data 602 and the hierarchy data 606 to generate example aggregated focus data 608. In some examples, the data aggregator circuitry 310 transmits the aggregated focus data 608 to the new product refresh circuitry 314. In some examples, the data aggregator circuitry 310 transmits the aggregated focus data 608 to the example data combiner circuitry 312.

The new product refresh circuitry 314 receives the benchmark channel data 604 and the aggregated focus data 608. The new product refresh circuitry 314 compares the benchmark channel data 604 and the aggregated focus data 608 to identify products in the benchmark channel data 604 corresponding to the category, but that are not in the aggregated focus data 608. That is, the new product refresh circuitry 314 compares the data sets to identify example new products 610. The new product refresh circuitry 314 transmits the new product(s) 610 to the data aggregator circuitry 310.

The data aggregator circuitry 310 aggregates the new product(s) and the benchmark channel data 604 to generated example aggregated benchmark data 612. In some examples, the data aggregator circuitry 310 transmits the aggregated benchmark data 612 to the example data combiner circuitry 312.

The example data combiner circuitry 312 receives the aggregated focus data 608 and the aggregated benchmark data 612 from the data aggregator circuitry 310. The example data combiner circuitry 312 combines the aggregated focus data 608 and the aggregated benchmark data 612 to generate an example combined products dataset 614. For example, the combined products dataset includes products sold in the benchmark channel and products sold in the focus channel. The data combiner circuitry 312 transmits the combined products dataset 614 to the example cluster circuitry 316.

The example cluster circuitry 316 analyzes the combined products dataset 614 and removes products that does not include recent sales data. For example, the cluster circuitry 316 may remove products that do not include sales data within a 3 month period. The cluster circuitry 316 also analyzes the combined products dataset 614 to identify common products (e.g., products sold in the benchmark channel and in the focus channel). The cluster circuitry 316 selects metrics on which to cluster the common products and applies a clustering technique (e.g., k-means clustering) to the common products. The cluster circuitry 316 adds the new product(s) to an output of the clustering process and determines a distance of a centroid of each cluster to the new product. For each cluster, the cluster circuitry 316 calculates a sales ratio (e.g., sales of focus products in the cluster divided by sales of benchmark products in the cluster). The cluster circuitry 316 multiplies each sales ratio by a respective inverse squared distance of the cluster to the new product to generate example weighted metric ratio(s) 616. The cluster circuitry 316 transmits the weighted metric ratio(s) 616 to the example metric determiner circuitry 324.

The example metric determiner circuitry 324 determines a performance metric for a new product identifies by the new product refresh circuitry 314. To do so, the metric determiner circuitry 324 identifies a benchmark channel metric value (e.g., ROS) for a new product. The metric determiner circuitry 324 multiplies the benchmark channel ROS for the new product by the weight metric ratio(s) to predict the focus channel ROS for the new product. Accordingly, the metric determiner circuitry 324 outputs an example metric estimation and associated data 618.

Flowcharts representative of example hardware logic circuitry, machine readable instructions, hardware implemented state machines, and/or any combination thereof for implementing the cross-channel analysis circuitry 218 of FIG. 2 are shown in FIGS. 7-11. The machine readable instructions may be one or more executable programs or portion(s) of an executable program for execution by processor circuitry, such as the processor circuitry 1212 shown in the example processor platform 1200 discussed below in connection with FIG. 12 and/or the example processor circuitry discussed below in connection with FIGS. 13 and/or 14. The program may be embodied in software stored on one or more non-transitory computer readable storage media such as a compact disk (CD), a floppy disk, a hard disk drive (HDD), a solid-state drive (SSD), a digital versatile disk (DVD), a Blu-ray disk, a volatile memory (e.g., Random Access Memory (RAM) of any type, etc.), or a non-volatile memory (e.g., electrically erasable programmable read-only memory (EEPROM), FLASH memory, an HDD, an SSD, etc.) associated with processor circuitry located in one or more hardware devices, but the entire program and/or parts thereof could alternatively be executed by one or more hardware devices other than the processor circuitry and/or embodied in firmware or dedicated hardware. The machine readable instructions may be distributed across multiple hardware devices and/or executed by two or more hardware devices (e.g., a server and a client hardware device). For example, the client hardware device may be implemented by an endpoint client hardware device (e.g., a hardware device associated with a user) or an intermediate client hardware device (e.g., a radio access network (RAN)) gateway that may facilitate communication between a server and an endpoint client hardware device). Similarly, the non-transitory computer readable storage media may include one or more mediums located in one or more hardware devices. Further, although the example program is described with reference to the flowcharts illustrated in FIGS. 7-11, many other methods of implementing the example cross-channel analysis circuitry 218 may alternatively be used. For example, the order of execution of the blocks may be changed, and/or some of the blocks described may be changed, eliminated, or combined. Additionally or alternatively, any or all of the blocks may be implemented by one or more hardware circuits (e.g., processor circuitry, discrete and/or integrated analog and/or digital circuitry, an FPGA, an ASIC, a comparator, an operational-amplifier (op-amp), a logic circuit, etc.) structured to perform the corresponding operation without executing software or firmware. The processor circuitry may be distributed in different network locations and/or local to one or more hardware devices (e.g., a single-core processor (e.g., a single core central processor unit (CPU)), a multi-core processor (e.g., a multi-core CPU, XPU, etc.) in a single machine, multiple processors distributed across multiple servers of a server rack, multiple processors distributed across one or more server racks, a CPU and/or a FPGA located in the same package (e.g., the same integrated circuit (IC) package or in two or more separate housings, etc.).

The machine readable instructions described herein may be stored in one or more of a compressed format, an encrypted format, a fragmented format, a compiled format, an executable format, a packaged format, etc. Machine readable instructions as described herein may be stored as data or a data structure (e.g., as portions of instructions, code, representations of code, etc.) that may be utilized to create, manufacture, and/or produce machine executable instructions. For example, the machine readable instructions may be fragmented and stored on one or more storage devices and/or computing devices (e.g., servers) located at the same or different locations of a network or collection of networks (e.g., in the cloud, in edge devices, etc.). The machine readable instructions may require one or more of installation, modification, adaptation, updating, combining, supplementing, configuring, decryption, decompression, unpacking, distribution, reassignment, compilation, etc., in order to make them directly readable, interpretable, and/or executable by a computing device and/or other machine. For example, the machine readable instructions may be stored in multiple parts, which are individually compressed, encrypted, and/or stored on separate computing devices, wherein the parts when decrypted, decompressed, and/or combined form a set of machine executable instructions that implement one or more operations that may together form a program such as that described herein.

In another example, the machine readable instructions may be stored in a state in which they may be read by processor circuitry, but require addition of a library (e.g., a dynamic link library (DLL)), a software development kit (SDK), an application programming interface (API), etc., in order to execute the machine readable instructions on a particular computing device or other device. In another example, the machine readable instructions may need to be configured (e.g., settings stored, data input, network addresses recorded, etc.) before the machine readable instructions and/or the corresponding program(s) can be executed in whole or in part. Thus, machine readable media, as used herein, may include machine readable instructions and/or program(s) regardless of the particular format or state of the machine readable instructions and/or program(s) when stored or otherwise at rest or in transit.

The machine readable instructions described herein can be represented by any past, present, or future instruction language, scripting language, programming language, etc. For example, the machine readable instructions may be represented using any of the following languages: C, C++, Java, C #, Perl, Python, JavaScript, HyperText Markup Language (HTML), Structured Query Language (SQL), Swift, etc.

As mentioned above, the example operations of FIGS. 7-11 may be implemented using executable instructions (e.g., computer and/or machine readable instructions) stored on one or more non-transitory computer and/or machine readable media such as optical storage devices, magnetic storage devices, an HDD, a flash memory, a read-only memory (ROM), a CD, a DVD, a cache, a RAM of any type, a register, and/or any other storage device or storage disk in which information is stored for any duration (e.g., for extended time periods, permanently, for brief instances, for temporarily buffering, and/or for caching of the information). As used herein, the terms non-transitory computer readable medium, non-transitory computer readable storage medium, non-transitory machine readable medium, and non-transitory machine readable storage medium are expressly defined to include any type of computer readable storage device and/or storage disk and to exclude propagating signals and to exclude transmission media. As used herein, the terms “computer readable storage device” and “machine readable storage device” are defined to include any physical (mechanical and/or electrical) structure to store information, but to exclude propagating signals and to exclude transmission media. Examples of computer readable storage devices and machine readable storage devices include random access memory of any type, read only memory of any type, solid state memory, flash memory, optical discs, magnetic disks, disk drives, and/or redundant array of independent disks (RAID) systems. As used herein, the term “device” refers to physical structure such as mechanical and/or electrical equipment, hardware, and/or circuitry that may or may not be configured by computer readable instructions, machine readable instructions, etc., and/or manufactured to execute computer readable instructions, machine readable instructions, etc.

“Including” and “comprising” (and all forms and tenses thereof) are used herein to be open ended terms. Thus, whenever a claim employs any form of “include” or “comprise” (e.g., comprises, includes, comprising, including, having, etc.) as a preamble or within a claim recitation of any kind, it is to be understood that additional elements, terms, etc., may be present without falling outside the scope of the corresponding claim or recitation. As used herein, when the phrase “at least” is used as the transition term in, for example, a preamble of a claim, it is open-ended in the same manner as the term “comprising” and “including” are open ended. The term “and/or” when used, for example, in a form such as A, B, and/or C refers to any combination or subset of A, B, C such as (1) A alone, (2) B alone, (3) C alone, (4) A with B, (5) A with C, (6) B with C, or (7) A with B and with C. As used herein in the context of describing structures, components, items, objects and/or things, the phrase “at least one of A and B” is intended to refer to implementations including any of (1) at least one A, (2) at least one B, or (3) at least one A and at least one B. Similarly, as used herein in the context of describing structures, components, items, objects and/or things, the phrase “at least one of A or B” is intended to refer to implementations including any of (1) at least one A, (2) at least one B, or (3) at least one A and at least one B. As used herein in the context of describing the performance or execution of processes, instructions, actions, activities and/or steps, the phrase “at least one of A and B” is intended to refer to implementations including any of (1) at least one A, (2) at least one B, or (3) at least one A and at least one B. Similarly, as used herein in the context of describing the performance or execution of processes, instructions, actions, activities and/or steps, the phrase “at least one of A or B” is intended to refer to implementations including any of (1) at least one A, (2) at least one B, or (3) at least one A and at least one B.

As used herein, singular references (e.g., “a”, “an”, “first”, “second”, etc.) do not exclude a plurality. The term “a” or “an” object, as used herein, refers to one or more of that object. The terms “a” (or “an”), “one or more”, and “at least one” are used interchangeably herein. Furthermore, although individually listed, a plurality of means, elements or method actions may be implemented by, e.g., the same entity or object. Additionally, although individual features may be included in different examples or claims, these may possibly be combined, and the inclusion in different examples or claims does not imply that a combination of features is not feasible and/or advantageous.

FIG. 7 is a flowchart representative of example machine readable instructions and/or example operations 700 that may be executed and/or instantiated by processor circuitry to predict a performance metric for a new product corresponding to a first channel based on data from a second channel. The machine readable instructions and/or the operations 700 of FIG. 7 begin at block 702, at which example data extraction circuitry (e.g., data extraction circuitry 302) receives a processed request (e.g., from example order processor circuitry 216 of FIG. 2) to estimate a performance metric for a new product(s). For example, the data extraction circuitry 302 can receive order details corresponding to order data (e.g., order data 210) from a market participant that has been processed by the order processor circuitry 216. In some examples, the order details include a focus channel, benchmark channel, a specific new product, a category of products, etc.

At block 704, the data extraction circuitry 302 identifies the focus channel and the benchmark channel from the processed request. The focus channel and/or the benchmark channel can be, for example, food/grocery, mass merchandize, drug, dollar, club, military, etc., for a specific universe (e.g., country, region, etc.). In some examples, the focus channel and/or the benchmark channel can be a specific retailer, a specific store, etc.

At block 706, the data extraction circuitry 302 extracts focus channel data (e.g., first data) corresponding to the focus channel from at least one database (e.g., retail measurement database(s) 206 and/or another database). For example, the data extraction circuitry 302 can extract a products dataset corresponding to the focus channel that includes all products belonging to a specific category (e.g., depending on the order data 210). In some examples, the focus channel data can include data from primary dimensions of the retail measurement database 206, including market data (e.g., channel information), products data (e.g., product specific attribute information, historical POS data, universal product codes (UPCs), etc.), time dimension data, and/or fact dimension information (e.g., as how much product was sold, value, value share, price, etc.)

At block 708, example hierarchy generator circuitry (e.g. hierarchy generator circuitry 304) generates at least one hierarchy based on a product category. In some examples, the hierarchy generator circuitry 304 selects a portion of a pre-established hierarchy associated with the focus channel. In some examples, the hierarchy generator circuitry 304 generates product hierarchy based on the extracted focus channel data. For example, the hierarchy generator circuitry 304 can select a category of products and levels of the hierarchy and place products within the focus channel data belonging to the category in nodes in respective levels of the hierarchy.

At block 710, example relationship mapper circuitry (e.g., relationship mapper circuitry 306) generates at least one relationship matrix. For example, the relationship mapper circuitry 306 can generate a relationship matrix that reflects different purchasing behavior for particular geographic regions within a market and/or sub-market. In some examples, the relationship matrix can be used to model the focus market and/or for forecasting effects of changing product assortment option(s). For example, the relationship matrix can be revised generated and revised in a manner that adds a new product of interest and identifies effect(s) of introducing such a product (with or without disturbing other product(s)).

At block 712, example data aggregator circuitry (e.g., data aggregator circuitry 310) aggregates the focus channel data to generate aggregated focus data. In some examples, the data aggregator circuitry 310 receives data from different components of the cross-channel analysis circuitry 218, processes the data, and outputs an aggregated dataset. For example, the data aggregator circuitry 310 can receive the focus channel data from the data extraction circuitry 302, a hierarchy from the hierarchy generator circuitry 304, and/or a relationship matrix from the example relationship mapper circuitry 306. In some examples, the data aggregator circuitry 310 can aggregate the data from the components in a table-like format that includes rows of products and columns of product facts to generate the aggregated focus data.

At block 714, example modeler circuitry (e.g., modeler circuitry 308) model the focus channel to generate coefficients. For example, the modeler circuitry 308 can utilize the hierarchy(ies) generated by the hierarchy generator circuitry 304 and/or a relationship matrix(ces) generated by the relationship mapper circuitry 306 to generate impact scores (e.g., coefficients) to quantify an impact of one product on another product. In some examples, the modeler circuitry 308 can calculate categorical impact for each product in a hierarchy using historical sales data. In some examples, a product can be weighted using sales data to establish a per-category impact score.

At block 716, the data extraction circuitry 302 extracts benchmark channel data (e.g., second data) corresponding to the benchmark channel from at least one database (e.g., retail measurement database(s) 206 and/or another database). For example, the data extraction circuitry 302 can extract a products dataset corresponding to the benchmark channel that includes all products belonging to a specific category (e.g., depending on the order data 210). In some examples, the benchmark channel data can include data from primary dimensions of the retail measurement database 206, including market data, products data, time dimension data, and/or fact dimension information.

At block 718, example new product refresh circuitry (e.g., new product refresh circuitry 314) identifies a new product(s) by comparing the benchmark channel data to the aggregated focus data. For example, the new product refresh circuitry 314 can compare the benchmark channel data to the aggregated focus data to identify products present in the benchmark channel data that are not present in the aggregated focus data. In doing so, the new product refresh circuitry 314 identifies products sold in the benchmark channel that are not sold in the focus channel.

At block 720, the new product refresh circuitry 314 adds the new product(s) to the modeled focus channel. For example, the new product refresh circuitry 314 can identify a spatial placement of the new product within the hierarchy(ies) generated by the hierarchy generator circuitry 304 for the focus channel. For example, the new product refresh circuitry 314 can identify a location for the new product(s) based on attributes of the products, geographic differences (e.g., expected channel influences within a geography), etc. Further, the new product refresh circuitry 314 can insert a new product row and a new product column into the relationship matrix(ces) generated by the relationship mapper circuitry 306 for the focus channel (e.g., based on attributes of the products, geographic differences, the hierarchy(ies), etc.).

At block 722, the data aggregator circuitry 310 aggregates the benchmark channel data to generate aggregated benchmark data. For example, the data aggregator circuitry 310 can receive the benchmark channel data from the data extraction circuitry 302 and/or information from the new product refresh circuitry 314 and aggregate the data in a table-like format that includes rows of products and columns of product facts.

At block 714, example data combiner circuitry (e.g., data combiner circuitry 312) combines (e.g., merges) the aggregated focus data and the aggregated benchmark data. For example, the data combiner circuitry 312 can receive the aggregated focus data and the aggregated benchmark data and combine the data based on related fields. In some examples, the data combiner circuitry 312 combines tables of the aggregated focus data and the aggregated benchmark data to generate a combined products dataset.

At block 726, example cluster circuitry (e.g., cluster circuitry 316) identifies and clusters common products, which are products sold in both the benchmark channel and the focus channel. For example, the cluster circuitry 316 can identify the common products and apply a clustering algorithm to group products within the common products that are similar based on selected metrics.

At block 728, example metric determiner circuitry 324 determines a performance metric estimation(s) for the new product(s). For example, based on the clusters generated by the cluster circuitry 316, the metric determiner circuitry 324 can predict one or more performance metrics for the new product if the focus channel were to add the new products to its assortment. For example, the metric determiner circuitry 324 can predict the ROS for the new product(s) based on the clusters of similar common products.

At block 730, example updater circuitry (e.g., updater circuitry 326) updates files associated with a retailer (e.g., corresponding to the focus channel) based on results of the cross-channel analysis. For example, the updater circuitry 326 can add tables generated by the cluster circuitry 316 to the files associated with the retailer. In some examples, the updater circuitry 326 can add a clustering output from the cluster circuitry 316 to the retailer's files to be used for additional analysis.

FIG. 8 is a flowchart representative of example machine readable instructions and/or example operations 726 that may be executed and/or instantiated by processor circuitry to cluster common products that are similar based on one or more metrics. The machine readable instructions and/or the operations 726 of FIG. 8 begin at block 802, at which example data refiner circuitry (e.g., data refiner circuitry 318) receives or otherwise retrieves the combined products dataset (e.g., the combined aggregated focus data and the aggregated benchmark data).

At block 804, the data refiner circuitry 318 identifies one or more products sold in the focus channel and in the benchmark channel to generate a dataset of common products. For example, the data refiner circuitry 318 can analyze the combined products dataset to identify products that are associated with both the focus channel and the benchmark channel, herein referred to as common products.

At block 806, the data refiner circuitry 318 removes products from the common products dataset that were sold beyond a defined period of time. For example, the data refiner circuitry 318 can analyze the common products data to identify products associated with the benchmark channel with sales data beyond a specific (e.g., threshold) date, period of time (e.g., a week, a month, a year, etc.) etc. The data refiner circuitry 318 can remove such identified products from the common products dataset. Further, the data refiner circuitry 318 can analyze the common products dataset to identify products associated with the focus channel with sales data beyond the threshold date and move identified products from the common products dataset. Thus, the common products dataset can include products that were relatively recently sold in both the focus channel and the benchmark channel, enabling better predictions.

At block 808, the data refiner circuitry 318 determines whether an amount of common products in the common products dataset exceeds a defined (e.g., threshold) amount. For example, the data refiner circuitry 318 can identify whether the benchmark channel and the focus channel sell enough common products such that the channels are similar in terms of types of shoppers who buy in both channels. For example, if the number of common products is below a certain threshold, such a result can indicate that the benchmark channel and the focus channel are too different in terms of the scope of products they carry and, therefore, in terms of the type of shoppers buying in both. If the answer to block 808 is NO (e.g., the amount of common products does not exceed a threshold amount), control advances to block 810 at which the cross-channel analysis circuitry 218 selects a new benchmark channel. Control then advances to block 716 of FIG. 6. If the answer to block 808 is YES (e.g., the amount of common products exceeds the threshold amount), control advances to block 812.

At block 812, example parameter determiner circuitry (e.g., parameter determiner circuitry 320) selects at least one metric on which to group the common products in the common products dataset. For example, the metrics can include price, velocity, distribution, promotional or standard, size or format, manufacturer versus private label, etc. In some examples, the parameter determiner circuitry 320 determines to cluster the common products based on a price metric, an ROS metric, a distribution metric, a format metric, and a sensitivity flag metric.

At block 814, the parameter determiner circuitry 320 determines a number of cluster, k, in which to cluster the common products. In some examples, the parameter determiner circuitry 320 determines the number of clusters using an elbow method and/or a silhouette method to select the number of clusters. For example, the cluster circuitry 316 can execute a clustering process for different values of k (e.g., by varying k from 1 to 10 clusters). The parameter determiner circuitry 320 can use outputs of the clustering process for the different values of k to determine and select an optimal or otherwise suitable number of clusters.

At block 816, the cluster circuitry 316 clusters the common products using a clustering technique to generate cluster output(s). For example, the cluster circuitry 316 can apply a k-means clustering technique to the common products dataset to cluster the common products based on the selected metrics and generate k clusters. The cluster circuitry 316 assigns data points representing common products to a cluster such that a sum of the squared distance between the data points and a centroid (e.g., arithmetic mean of all the data points that belong to that cluster) is at the minimum. At block 818, the cluster circuitry 316 outputs a clustering output that includes k clusters of the common products, centroids of the clusters, and/or ratios corresponding to the clusters. In some examples, the clustering output includes common products represented by data points that are clustered such that common products in the same cluster are as similar as possible, and common products in different clusters are as dissimilar as possible.

FIG. 9 is a flowchart representative of example machine readable instructions and/or example operations 816 that may be executed and/or instantiated by processor circuitry to clusters the common products using a clustering technique to generate cluster output(s). The machine readable instructions and/or the operations 816 of FIG. 9 begin at block 902, at which the cluster circuitry 316 cluster circuitry 316 selects k points to be initial centroids. For example, the k initial centroids can be randomly selected based on the common products. In some examples, the k initial centroids can be selected based on an evaluation method based on the aggregated benchmark data.

At block 904, the cluster circuitry 316 assigns each common product to a closest initial centroid based on the aggregated benchmark data to form k initial clusters. For example, the cluster circuitry 316 can compute a sum of the squared distance between each of the common products (e.g., a data points) and each of the initial centroids. The cluster circuitry 316 can assign each common product to the closest initial cluster (e.g., initial centroid) based on the calculations.

At block 906, the cluster circuitry 316 computes centroids of the initial clusters. For example, for each initial cluster, the cluster circuitry 316 can compute a centroid by computing an average of the data points within a respective cluster.

At block 908, the cluster circuitry 316 determines current centroids for clustering. Typically, the k-means and/or other clustering techniques apply an iterative process in which data points clustered numerous times. In different iterations, different centroids are typically used for clustering. Thus, the cluster circuitry 316 determines which centroids around which to cluster the common products for each iteration. In some examples, the current centroids are the initial centroids. In some examples, the current centroids are centroids computed after a clustering iterations is completed.

At block 910, the cluster circuitry 316 re-assigns each common product to a closest current centroid based on the aggregated benchmark data to form k new clusters. For example, the cluster circuitry 316 can assign each common product to the closest current cluster (e.g., initial centroid, new centroid(s), etc.) based on calculated sums of the squared distances between each of the common products (e.g., a data points) and each of the current centroids.

At block 912, the cluster circuitry 316 computes centroids of the new clusters to be new centroids. For example, the cluster circuitry 316 can compute the new centroids by computing an average of the common products (e.g., data points) within each of the new clusters. That is, each new cluster's centroid is calculated by averaging the re-assigned data points within the new clusters.

At block 914, the cluster circuitry 316 compares the new centroids to the current centroids to identify an amount of change, if any between the current centroids and the new centroids. For example, the cluster circuitry 316 can compare the new centroids to the current centroids by calculating a distance between a first one of the new centroids and a respective first one of the current centroids. Similarly, the cluster circuitry 316 can compare the new centroids to the current centroids by calculating a distance between a second one of the new centroids and a respective second one of the current centroids.

At block 916, the cluster circuitry 316 determines whether a convergence criterion is satisfied. For example, the cluster circuitry 316 can determine whether a convergence criterion that controls a minimum change in cluster centroids is satisfied. In some examples, the convergence criterion is a value (e.g., between 0 and 1) that represents a proportion of a minimum distance among the new centroids. For example, a convergence criterion of 0.02 would be satisfied when a complete iteration resulting in the new centroids does not move the current centroids to the new centroids by a distance of more than 2% of the smallest distance among the current centroids. However, other convergence criterion can be used in additional or alternative examples. If the answer to block 916 is YES (e.g., the convergence criterion is satisfied), control advances to block 920 at which the cluster circuitry 316 stops iterating through the clustering process. If the answer to block 914 is NO (e.g., the convergence criterion is not satisfied), control advances to block 918.

At block 918, the cluster circuitry 316 determines whether a maximum defined number of iterations have been completed. The maximum defined number of iterations limits the number of iterations of applying the k-means algorithm. For example, the cluster circuitry 316 can stop iterating through the clustering process when the maximum defined number of iterations are completed, even if the convergence criterion is not satisfied. In some examples, the maximum defined number of iterations is between 0 and 999 (e.g., 10).

If the answer to block 918 is YES (e.g., the cluster circuitry 316 has completed the defined maximum number of iterations), control advances to block 920 at which the cluster circuitry 316 stops the clustering iterations. If the answer to block 916 is NO (e.g., the cluster circuitry 316 has not completed the defined maximum number of iterations), control returns to block 908, at which the cluster circuitry 316 determines current centroids for clustering. For example, the cluster circuitry 316 can determine that the new centroids are the current centroids for clustering. In some examples, the cluster circuitry 316 iterates through the clustering process until convergence is achieve and/or until the maximum defined number of iterations have been completed.

FIG. 10 is a flowchart representative of example machine readable instructions and/or example operations 728 that may be executed and/or instantiated by processor circuitry to determine a performance metric estimation(s) (e.g., ROS, etc.) for the new product(s). The machine readable instructions and/or the operations 728 of FIG. 10 begin at block 1002, at which the cluster circuitry 316 adds a new product(s) to the clustering output. For example, the cluster circuitry 316 can add the new product(s) to the clustering output based on the selected metrics and benchmark data for the new product(s).

At block 1004, example adjustment determiner circuitry (e.g., adjustment determiner circuitry 322) determines least one distance of each centroid to the new product(s). For example, the adjustment determiner circuitry 322 can determine a distance from a centroid to a new product by calculating a Euclidean distance, a squared Euclidean distance, Chebyshev distance, Manhattan distance, etc. distance of the centroid to a data point representing the new product. In some examples, the adjustment determiner circuitry 322 determines an inverse squared distance of each centroid to the new product. That is, for each determined distance, the adjustment determiner circuitry 322 can compute an inverse square of the calculated distances.

At block 1006, the adjustment determiner circuitry determines (e.g., calculates) a ratio of a performance metric (e.g., rate of sales (ROS)) (e.g., a sales adjustment) of the focus channel to the benchmark channel by cluster based on the common products within at least one cluster. For example, the adjustment determiner circuitry 322 can determine a ratio of sales for all the cluster, clusters within a threshold distance of the new products, a closest cluster, etc. It is understood that ratios of other performance metrics can be calculated in additional or alternative examples. In some examples, a first ratio of the ROS can be calculated by dividing a ROS for the common products with a first cluster based on the focus data by a ROS for the common products within the first cluster based on the benchmark data. In some examples, the ratios can be determine in additional or alternative manners. In some examples, the ratio(s) are used to adjust (e.g., scale up or scale down) the benchmark sales data before using the benchmark sales data for the new product to estimate focus channel sales data for the new product.

At block 1008, the adjustment determiner circuitry 322 multiplies each ratio of the performance metric(s) by the inverse squared distance of a respective cluster to generate weight ratios. For example, the cluster circuitry the inverse squared distances are used to apply a weight to the ratio of sales for a cluster to generate adjusted (e.g., weighted) ratio(s) of sales. As such, a cluster that is closer to the new products and, thus, more similar to the new products can receive a higher weight than a product that is further away from the new product.

At block 1010, example metric determiner circuitry (e.g., metric determiner circuitry 324) identifies a value of the performance metric(s) of the new product corresponding to the benchmark channel data. That is, the metric determiner circuitry 324 searches the aggregated benchmark data to identify a value for the performance metric for the new product. For example, the metric determiner circuitry 324 can identify a ROS for the new product based on the aggregated benchmark data.

At block 1012, the metric determiner circuitry 324 multiplies the value of the performance metric of the new product from the benchmark channel by at least one of the weighted ratio. For example, the metric determiner circuitry 324 can multiply the value of the performance metric of the new product from the benchmark channel by a weighted ratio of the centroid that is closest to the new product. In some examples, the metric determiner circuitry 324 can multiply the value of the performance metric of the new product from the benchmark channel by each of the weight ratios.

At block 1014, the metric determiner circuitry 324 outputs a predicted value of the performance metric(s) for the new product for the focus channel. That is, the metric determiner circuitry 324 outputs a prediction for the new product for the focus channel if the focus channel were to sell the new product. For example, the metric determiner circuitry 324 can output an prediction (e.g., estimation) of a ROS for the new product as if the new product were selling in the focus channel.

FIG. 11 is a flowchart representative of example machine readable instructions and/or example operations 730 that may be executed and/or instantiated by processor circuitry to update retailer files based on results of the cross-channel analysis. The machine readable instructions and/or the operations 730 of FIG. 11 begin at block 1102, at which example updater circuitry (e.g., updater circuitry 326) generates new coefficients based on the addition of the new product(s) to the modeled focus channel. For example, the updater circuitry 326 can calculate coefficients for the new products using cells associated with existing products that surround the cells associated with the new product. The new coefficients can be generated by the updater circuitry 326 in any manner including, but not limited to, averaging, curve fitting, geometric weighting techniques, calculating a weighted mathematical average of sibling matrix cells, etc.

At block 1104, the updater circuitry 326 retrieves a cluster defining table from the cluster circuitry 316. For example, the cluster circuitry 316 can generate a cluster definition table that provides products making up each cluster by combination of retailers (e.g., focus channel retailers and benchmark channel retailers). The updater circuitry 326 can retrieve the cluster definition table for upload to a platform.

At block 1104, the updater circuitry 326 retrieves a cluster assignment table from the cluster circuitry 316. For example, the cluster circuitry 316 can generate a cluster assignment table that assigns a cluster to work for each product by combination of retailers (e.g., focus channel retailers and benchmark channel retailers). The updater circuitry 326 can retrieve the cluster assignment table for upload to a platform.

At block 1106, the updater circuitry 326 uploads the cluster defining table and/or the cluster assignment table to an example platform having an interface for a market participant (e.g., a retailer of the focus channel) to access and utilize the data by. For example, the platform can be a operated by the market research entity to provide data, analytics, insights, etc. to market participants.

FIG. 12 is a block diagram of an example processor platform 1200 structured to execute and/or instantiate the machine readable instructions and/or the operations of FIGS. 7-11 to implement the cross-channel analysis circuitry 218 of FIG. 3. The processor platform 1200 can be, for example, a server, a personal computer, a workstation, a self-learning machine (e.g., a neural network), a mobile device (e.g., a cell phone, a smart phone, a tablet such as an iPad™), a personal digital assistant (PDA), an Internet appliance, a DVD player, a CD player, a digital video recorder, a Blu-ray player, a gaming console, a personal video recorder, a set top box, a headset (e.g., an augmented reality (AR) headset, a virtual reality (VR) headset, etc.) or other wearable device, or any other type of computing device.

The processor platform 1200 of the illustrated example includes processor circuitry 1212. The processor circuitry 1212 of the illustrated example is hardware. For example, the processor circuitry 1212 can be implemented by one or more integrated circuits, logic circuits, FPGAs, microprocessors, CPUs, GPUs, DSPs, and/or microcontrollers from any desired family or manufacturer. The processor circuitry 1212 may be implemented by one or more semiconductor based (e.g., silicon based) devices. In this example, the processor circuitry 1212 implements example ordering user interface circuitry 208, example order processor circuitry 216, example cross-channel analysis circuitry 218, example report generator circuitry 220, example data extraction circuitry 302, example hierarchy generator circuitry 304, example relationship mapper circuitry 306, example modeler circuitry 308, example data aggregator circuitry 310, example data combiner circuitry 312, example new product refresh circuitry 314, example cluster circuitry 316, example data refiner circuitry 318, example parameter determiner circuitry 320, example adjustment determiner circuitry 322, example metric determiner circuitry 324, and/or example updater circuitry 326.

The processor circuitry 1212 of the illustrated example includes a local memory 1213 (e.g., a cache, registers, etc.). The processor circuitry 1212 of the illustrated example is in communication with a main memory including a volatile memory 1214 and a non-volatile memory 1216 by a bus 1218. The volatile memory 1214 may be implemented by Synchronous Dynamic Random Access Memory (SDRAM), Dynamic Random Access Memory (DRAM), RAMBUS® Dynamic Random Access Memory (RDRAM®), and/or any other type of RAM device. The non-volatile memory 1216 may be implemented by flash memory and/or any other desired type of memory device. Access to the main memory 1214, 1216 of the illustrated example is controlled by a memory controller 1217.

The processor platform 1200 of the illustrated example also includes interface circuitry 1220. The interface circuitry 1220 may be implemented by hardware in accordance with any type of interface standard, such as an Ethernet interface, a universal serial bus (USB) interface, a Bluetooth® interface, a near field communication (NFC) interface, a Peripheral Component Interconnect (PCI) interface, and/or a Peripheral Component Interconnect Express (PCIe) interface.

In the illustrated example, one or more input devices 1222 are connected to the interface circuitry 1220. The input device(s) 1222 permit(s) a user to enter data and/or commands into the processor circuitry 1212. The input device(s) 1222 can be implemented by, for example, an audio sensor, a microphone, a camera (still or video), a keyboard, a button, a mouse, a touchscreen, a track-pad, a trackball, an isopoint device, and/or a voice recognition system.

One or more output devices 1224 are also connected to the interface circuitry 1220 of the illustrated example. The output device(s) 1224 can be implemented, for example, by display devices (e.g., a light emitting diode (LED), an organic light emitting diode (OLED), a liquid crystal display (LCD), a cathode ray tube (CRT) display, an in-place switching (IPS) display, a touchscreen, etc.), a tactile output device, a printer, and/or speaker. The interface circuitry 1220 of the illustrated example, thus, typically includes a graphics driver card, a graphics driver chip, and/or graphics processor circuitry such as a GPU.

The interface circuitry 1220 of the illustrated example also includes a communication device such as a transmitter, a receiver, a transceiver, a modem, a residential gateway, a wireless access point, and/or a network interface to facilitate exchange of data with external machines (e.g., computing devices of any kind) by a network 1226. The communication can be by, for example, an Ethernet connection, a digital subscriber line (DSL) connection, a telephone line connection, a coaxial cable system, a satellite system, a line-of-site wireless system, a cellular telephone system, an optical connection, etc.

The processor platform 1200 of the illustrated example also includes one or more mass storage devices 1228 to store software and/or data. Examples of such mass storage devices 1228 include magnetic storage devices, optical storage devices, floppy disk drives, HDDs, CDs, Blu-ray disk drives, redundant array of independent disks (RAID) systems, solid state storage devices such as flash memory devices and/or SSDs, and DVD drives.

The machine readable instructions 1232, which may be implemented by the machine readable instructions of FIGS. 7-11, may be stored in the mass storage device 1228, in the volatile memory 1214, in the non-volatile memory 1216, and/or on a removable non-transitory computer readable storage medium such as a CD or DVD.

FIG. 13 is a block diagram of an example implementation of the processor circuitry 1212 of FIG. 12. In this example, the processor circuitry 1212 of FIG. 12 is implemented by a microprocessor 1300. For example, the microprocessor 1300 may be a general purpose microprocessor (e.g., general purpose microprocessor circuitry). The microprocessor 1300 executes some or all of the machine readable instructions of the flowcharts of FIGS. 7-11 to effectively instantiate the circuitry of FIG. 3 as logic circuits to perform the operations corresponding to those machine readable instructions. In some such examples, the circuitry of FIG. 3 is instantiated by the hardware circuits of the microprocessor 1300 in combination with the instructions. For example, the microprocessor 1300 may be implemented by multi-core hardware circuitry such as a CPU, a DSP, a GPU, an XPU, etc. Although it may include any number of example cores 1302 (e.g., 1 core), the microprocessor 1300 of this example is a multi-core semiconductor device including N cores. The cores 1302 of the microprocessor 1300 may operate independently or may cooperate to execute machine readable instructions. For example, machine code corresponding to a firmware program, an embedded software program, or a software program may be executed by one of the cores 1302 or may be executed by multiple ones of the cores 1302 at the same or different times. In some examples, the machine code corresponding to the firmware program, the embedded software program, or the software program is split into threads and executed in parallel by two or more of the cores 1302. The software program may correspond to a portion or all of the machine readable instructions and/or operations represented by the flowcharts of FIGS. 7-11.

The cores 1302 may communicate by a first example bus 1304. In some examples, the first bus 1304 may be implemented by a communication bus to effectuate communication associated with one(s) of the cores 1302. For example, the first bus 1304 may be implemented by at least one of an Inter-Integrated Circuit (I2C) bus, a Serial Peripheral Interface (SPI) bus, a PCI bus, or a PCIe bus. Additionally or alternatively, the first bus 1304 may be implemented by any other type of computing or electrical bus. The cores 1302 may obtain data, instructions, and/or signals from one or more external devices by example interface circuitry 1306. The cores 1302 may output data, instructions, and/or signals to the one or more external devices by the interface circuitry 1306. Although the cores 1302 of this example include example local memory 1320 (e.g., Level 1 (L1) cache that may be split into an L1 data cache and an L1 instruction cache), the microprocessor 1300 also includes example shared memory 1310 that may be shared by the cores (e.g., Level 2 (L2_cache)) for high-speed access to data and/or instructions. Data and/or instructions may be transferred (e.g., shared) by writing to and/or reading from the shared memory 1310. The local memory 1320 of each of the cores 1302 and the shared memory 1310 may be part of a hierarchy of storage devices including multiple levels of cache memory and the main memory (e.g., the main memory 1214, 1216 of FIG. 12). Typically, higher levels of memory in the hierarchy exhibit lower access time and have smaller storage capacity than lower levels of memory. Changes in the various levels of the cache hierarchy are managed (e.g., coordinated) by a cache coherency policy.

Each core 1302 may be referred to as a CPU, DSP, GPU, etc., or any other type of hardware circuitry. Each core 1302 includes control unit circuitry 1314, arithmetic and logic (AL) circuitry (sometimes referred to as an ALU) 1316, a plurality of registers 1318, the local memory 1320, and a second example bus 1322. Other structures may be present. For example, each core 1302 may include vector unit circuitry, single instruction multiple data (SIMD) unit circuitry, load/store unit (LSU) circuitry, branch/jump unit circuitry, floating-point unit (FPU) circuitry, etc. The control unit circuitry 1314 includes semiconductor-based circuits structured to control (e.g., coordinate) data movement within the corresponding core 1302. The AL circuitry 1316 includes semiconductor-based circuits structured to perform one or more mathematic and/or logic operations on the data within the corresponding core 1302. The AL circuitry 1316 of some examples performs integer based operations. In other examples, the AL circuitry 1316 also performs floating point operations. In yet other examples, the AL circuitry 1316 may include first AL circuitry that performs integer based operations and second AL circuitry that performs floating point operations. In some examples, the AL circuitry 1316 may be referred to as an Arithmetic Logic Unit (ALU). The registers 1318 are semiconductor-based structures to store data and/or instructions such as results of one or more of the operations performed by the AL circuitry 1316 of the corresponding core 1302. For example, the registers 1318 may include vector register(s), SIMD register(s), general purpose register(s), flag register(s), segment register(s), machine specific register(s), instruction pointer register(s), control register(s), debug register(s), memory management register(s), machine check register(s), etc. The registers 1318 may be arranged in a bank as shown in FIG. 13. Alternatively, the registers 1318 may be organized in any other arrangement, format, or structure including distributed throughout the core 1302 to shorten access time. The second bus 1322 may be implemented by at least one of an I2C bus, a SPI bus, a PCI bus, or a PCIe bus

Each core 1302 and/or, more generally, the microprocessor 1300 may include additional and/or alternate structures to those shown and described above. For example, one or more clock circuits, one or more power supplies, one or more power gates, one or more cache home agents (CHAs), one or more converged/common mesh stops (CMSs), one or more shifters (e.g., barrel shifter(s)) and/or other circuitry may be present. The microprocessor 1300 is a semiconductor device fabricated to include many transistors interconnected to implement the structures described above in one or more integrated circuits (ICs) contained in one or more packages. The processor circuitry may include and/or cooperate with one or more accelerators. In some examples, accelerators are implemented by logic circuitry to perform certain tasks more quickly and/or efficiently than can be done by a general purpose processor. Examples of accelerators include ASICs and FPGAs such as those discussed herein. A GPU or other programmable device can also be an accelerator. Accelerators may be on-board the processor circuitry, in the same chip package as the processor circuitry and/or in one or more separate packages from the processor circuitry.

FIG. 14 is a block diagram of another example implementation of the processor circuitry 1212 of FIG. 12. In this example, the processor circuitry 1212 is implemented by FPGA circuitry 1400. For example, the FPGA circuitry 1400 may be implemented by an FPGA. The FPGA circuitry 1400 can be used, for example, to perform operations that could otherwise be performed by the example microprocessor 1300 of FIG. 13 executing corresponding machine readable instructions. However, once configured, the FPGA circuitry 1400 instantiates the machine readable instructions in hardware and, thus, can often execute the operations faster than they could be performed by a general purpose microprocessor executing the corresponding software.

More specifically, in contrast to the microprocessor 1300 of FIG. 13 described above (which is a general purpose device that may be programmed to execute some or all of the machine readable instructions represented by the flowcharts of FIGS. 7-11 but whose interconnections and logic circuitry are fixed once fabricated), the FPGA circuitry 1400 of the example of FIG. 14 includes interconnections and logic circuitry that may be configured and/or interconnected in different ways after fabrication to instantiate, for example, some or all of the machine readable instructions represented by the flowcharts of FIGS. 7-11. In particular, the FPGA circuitry 1400 may be thought of as an array of logic gates, interconnections, and switches. The switches can be programmed to change how the logic gates are interconnected by the interconnections, effectively forming one or more dedicated logic circuits (unless and until the FPGA circuitry 1400 is reprogrammed). The configured logic circuits enable the logic gates to cooperate in different ways to perform different operations on data received by input circuitry. Those operations may correspond to some or all of the software represented by the flowcharts of FIGS. 7-11. As such, the FPGA circuitry 1400 may be structured to effectively instantiate some or all of the machine readable instructions of the flowcharts of FIGS. 7-11 as dedicated logic circuits to perform the operations corresponding to those software instructions in a dedicated manner analogous to an ASIC. Therefore, the FPGA circuitry 1400 may perform the operations corresponding to the some or all of the machine readable instructions of FIGS. 7-11 faster than the general purpose microprocessor can execute the same.

In the example of FIG. 14, the FPGA circuitry 1400 is structured to be programmed (and/or reprogrammed one or more times) by an end user by a hardware description language (HDL) such as Verilog. The FPGA circuitry 1400 of FIG. 14, includes example input/output (I/O) circuitry 1402 to obtain and/or output data to/from example configuration circuitry 1404 and/or external hardware 1406. For example, the configuration circuitry 1404 may be implemented by interface circuitry that may obtain machine readable instructions to configure the FPGA circuitry 1400, or portion(s) thereof. In some such examples, the configuration circuitry 1404 may obtain the machine readable instructions from a user, a machine (e.g., hardware circuitry (e.g., programmed or dedicated circuitry) that may implement an Artificial Intelligence/Machine Learning (AI/ML) model to generate the instructions), etc. In some examples, the external hardware 1406 may be implemented by external hardware circuitry. For example, the external hardware 1406 may be implemented by the microprocessor 1300 of FIG. 13. The FPGA circuitry 1400 also includes an array of example logic gate circuitry 1408, a plurality of example configurable interconnections 1410, and example storage circuitry 1412. The logic gate circuitry 1408 and the configurable interconnections 1410 are configurable to instantiate one or more operations that may correspond to at least some of the machine readable instructions of FIGS. 7-11 and/or other desired operations. The logic gate circuitry 1408 shown in FIG. 14 is fabricated in groups or blocks. Each block includes semiconductor-based electrical structures that may be configured into logic circuits. In some examples, the electrical structures include logic gates (e.g., And gates, Or gates, Nor gates, etc.) that provide basic building blocks for logic circuits. Electrically controllable switches (e.g., transistors) are present within each of the logic gate circuitry 1408 to enable configuration of the electrical structures and/or the logic gates to form circuits to perform desired operations. The logic gate circuitry 1408 may include other electrical structures such as look-up tables (LUTs), registers (e.g., flip-flops or latches), multiplexers, etc.

The configurable interconnections 1410 of the illustrated example are conductive pathways, traces, vias, or the like that may include electrically controllable switches (e.g., transistors) whose state can be changed by programming (e.g., using an HDL instruction language) to activate or deactivate one or more connections between one or more of the logic gate circuitry 1408 to program desired logic circuits.

The storage circuitry 1412 of the illustrated example is structured to store result(s) of the one or more of the operations performed by corresponding logic gates. The storage circuitry 1412 may be implemented by registers or the like. In the illustrated example, the storage circuitry 1412 is distributed amongst the logic gate circuitry 1408 to facilitate access and increase execution speed.

The example FPGA circuitry 1400 of FIG. 14 also includes example Dedicated Operations Circuitry 1414. In this example, the Dedicated Operations Circuitry 1414 includes special purpose circuitry 1416 that may be invoked to implement commonly used functions to avoid the need to program those functions in the field. Examples of such special purpose circuitry 1416 include memory (e.g., DRAM) controller circuitry, PCIe controller circuitry, clock circuitry, transceiver circuitry, memory, and multiplier-accumulator circuitry. Other types of special purpose circuitry may be present. In some examples, the FPGA circuitry 1400 may also include example general purpose programmable circuitry 1418 such as an example CPU 1420 and/or an example DSP 1422. Other general purpose programmable circuitry 1418 may additionally or alternatively be present such as a GPU, an XPU, etc., that can be programmed to perform other operations.

Although FIGS. 13 and 14 illustrate two example implementations of the processor circuitry 1212 of FIG. 12, many other approaches are contemplated. For example, as mentioned above, modem FPGA circuitry may include an on-board CPU, such as one or more of the example CPU 1420 of FIG. 14. Therefore, the processor circuitry 1212 of FIG. 12 may additionally be implemented by combining the example microprocessor 1300 of FIG. 13 and the example FPGA circuitry 1400 of FIG. 14. In some such hybrid examples, a first portion of the machine readable instructions represented by the flowcharts of FIGS. 7-11 may be executed by one or more of the cores 1302 of FIG. 13, a second portion of the machine readable instructions represented by the flowcharts of FIGS. 7-11 may be executed by the FPGA circuitry 1400 of FIG. 14, and/or a third portion of the machine readable instructions represented by the flowcharts of FIGS. 7-11 may be executed by an ASIC. It should be understood that some or all of the circuitry of FIG. 3 may, thus, be instantiated at the same or different times. Some or all of the circuitry may be instantiated, for example, in one or more threads executing concurrently and/or in series. Moreover, in some examples, some or all of the circuitry of FIG. 3 may be implemented within one or more virtual machines and/or containers executing on the microprocessor.

In some examples, the processor circuitry 1212 of FIG. 12 may be in one or more packages. For example, the microprocessor 1300 of FIG. 13 and/or the FPGA circuitry 1400 of FIG. 14 may be in one or more packages. In some examples, an XPU may be implemented by the processor circuitry 1212 of FIG. 12, which may be in one or more packages. For example, the XPU may include a CPU in one package, a DSP in another package, a GPU in yet another package, and an FPGA in still yet another package.

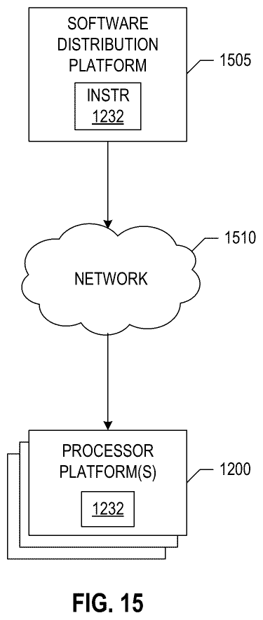

A block diagram illustrating an example software distribution platform 1505 to distribute software such as the example machine readable instructions 1232 of FIG. 12 to hardware devices owned and/or operated by third parties is illustrated in FIG. 15. The example software distribution platform 1505 may be implemented by any computer server, data facility, cloud service, etc., capable of storing and transmitting software to other computing devices. The third parties may be customers of the entity owning and/or operating the software distribution platform 1505. For example, the entity that owns and/or operates the software distribution platform 1505 may be a developer, a seller, and/or a licensor of software such as the example machine readable instructions 1232 of FIG. 12. The third parties may be consumers, users, retailers, OEMs, etc., who purchase and/or license the software for use and/or re-sale and/or sub-licensing. In the illustrated example, the software distribution platform 1505 includes one or more servers and one or more storage devices. The storage devices store the machine readable instructions 1232, which may correspond to the example machine readable instructions 700 of FIGS. 7-11, as described above. The one or more servers of the example software distribution platform 1505 are in communication with an example network 1510, which may correspond to any one or more of the Internet and/or any of the example networks 204, 1226 described above. In some examples, the one or more servers are responsive to requests to transmit the software to a requesting party as part of a commercial transaction. Payment for the delivery, sale, and/or license of the software may be handled by the one or more servers of the software distribution platform and/or by a third party payment entity. The servers enable purchasers and/or licensors to download the machine readable instructions 1232 from the software distribution platform 1505. For example, the software, which may correspond to the example machine readable instructions 1232 of FIG. 12, may be downloaded to the example processor platform 1200, which is to execute the machine readable instructions 1232 to implement the cross-channel analysis circuitry 218. In some examples, one or more servers of the software distribution platform 1505 periodically offer, transmit, and/or force updates to the software (e.g., the example machine readable instructions 1232 of FIG. 12) to ensure improvements, patches, updates, etc., are distributed and applied to the software at the end user devices.

From the foregoing, it will be appreciated that example systems, methods, apparatus, and articles of manufacture have been disclosed that facilitate prediction of a performance metric of a new product that has not been sold in a first channel based on data from a second channel in which the new product has sold using cross-channel analytics techniques. Disclosed systems, methods, apparatus, and articles of manufacture improve the efficiency of using a computing device by extracting large datasets from a database having millions of products for over 900,000 retailers, comparing the large datasets to identify new products and to identify common products between the large datasets to generate a common products dataset, refining the common products data by removing products with sales data beyond a defined period of time, and clustering groups of alike common products based on specific metrics. In some examples, the common products are grouped multiple times to determine a number of clusters that can product the best or otherwise accurate results. Disclosed systems, methods, apparatus, and articles of manufacture are accordingly directed to one or more improvement(s) in the operation of a machine such as a computer or other electronic and/or mechanical device.

Example methods, systems, and apparatus to determine new product metrics using cross-channel analytics are disclosed herein. Further examples and combinations thereof include the following:

Example 1 includes an apparatus comprising memory, machine readable instructions, and processor circuitry to execute the machine readable instructions to at least compare first products data associated with a first channel and second products data associated with a second channel to identify (a) a product of interest corresponding to a product present only in the second products data, and (b) common products data corresponding to common products that are present in both the first products data and the second products data, cluster the common products based on at least one metric to generate product clusters in a cluster output, for ones of the product clusters in the cluster output, calculate a ratio of a performance metric of the common products based on the first products data to the second products data, and determine a value of a performance metric for the product of interest based on the second products data and at least one ratio of the performance metric.

Example 2 includes the apparatus of example 1, wherein the first channel is a channel of interest, and wherein the second channel is a benchmark channel.

Example 3 includes the apparatus of any preceding example, wherein the first products data includes data corresponding to first products associated with a category of products, the data corresponding to the first products associated with the first channel.

Example 4 includes the apparatus of any preceding example, wherein the second products data includes data corresponding to second products associated with the category of products, the data corresponding to the second products associated with the second channel.

Example 5 includes the apparatus of any preceding example, wherein, prior to clustering the common products, the processor circuitry executes the instructions to remove ones of the common products from the common products data associated with data collected beyond a defined period of time.

Example 6 includes the apparatus of any preceding example, wherein the common products are clustered using a k-means clustering technique.

Example 7 includes the apparatus of any preceding example, wherein a number of clusters is determined using at least one of an elbow method or a silhouette method.

Example 8 includes the apparatus of any preceding example, wherein the common products are clustered based on the second products data associated with the second channel.

Example 9 includes the apparatus of any preceding example, wherein, to determine the value of the performance metric for the product of interest, the processor executes the instructions to identify a first value for the performance metric for the product of interest from the second products data, and multiply the first value for the performance metric by the at least one ratio.

Example 10 includes the apparatus of any preceding example, wherein, prior to multiplying the first value for the performance metric by the at least one ratio, the processor circuitry further executes the instructions to add the product of interest to the cluster output, determine a distance of ones of the product clusters to the product of interest, determine an inverse squared distance of the ones of the product clusters to the product of interest, multiply ones of the ratios of the performance metric for the product clusters by a respective inverse squared distance to generate weighted ratios of the performance metric, and multiply the first value for the performance metric by the weighted ratios of the product clusters to generate the value of the performance metric.

Example 11 includes a non-transitory machine readable storage medium comprising instructions that, when executed, cause processor circuitry to at least compare a first dataset associated with a focus channel and a second dataset data associated with a reference channel to identify (a) a target product corresponding to a product present in the second dataset and not in the first dataset, and (b) proxy products corresponding to products present in the first dataset and the second dataset, cluster the proxy products into product clusters based on at least one metric to generate a cluster output that includes the product clusters, for ones of the product clusters in the cluster output, determine a ratio of a performance metric of the proxy products based on data from the first dataset to data from the second dataset to generate performance metric ratios, and predict a value of a performance metric for the target product based on data from the second dataset and at least one performance metric ration of the performance metric ratios.

Example 12 includes the non-transitory machine readable storage medium of example 11, wherein the target channel is a channel of interest, and wherein the reference channel is a benchmark channel.

Example 13 includes the non-transitory machine readable storage medium of any preceding example, wherein the first dataset includes data corresponding to first products associated with a category of products, the data corresponding to the first products associated with the target channel.

Example 14 includes the non-transitory machine readable storage medium of any preceding example, wherein the second products data includes data corresponding to second products associated with the category of products, the data corresponding to the second products associated with the reference channel.

Example 15 includes the non-transitory machine readable storage medium of any preceding example, wherein, prior to clustering the proxy products, the processor circuitry is to remove ones of the proxy products having data corresponding to the performance metric that is associated with a date beyond a threshold period of time.

Example 16 includes the non-transitory machine readable storage medium of any preceding example, wherein the proxy products are clustered using a k-means clustering technique.

Example 17 includes the non-transitory machine readable storage medium of any preceding example, wherein a number of clusters is determined using an elbow method.

Example 18 includes the non-transitory machine readable storage medium of any preceding example, wherein the proxy products are clustered based on data from the second dataset associated with the reference channel.

Example 19 includes the non-transitory machine readable storage medium of any preceding example, wherein, to predict the value of the performance metric for the target product, the processor circuitry identifies a first value for the performance metric for the target product based on data from the second dataset, and multiplies the first value for the performance metric by the at least one performance metric ratio.

Example 20 includes the non-transitory machine readable storage medium of any preceding example, wherein, prior to multiplying the first value for the performance metric by the at least one performance ratio, the processor circuitry adds the target product to the cluster output, determines a distance of ones of the product clusters to the target product, determines an inverse squared distance of the ones of the product clusters to the target product, multiplies ones of the performance metric ratios for the product clusters by a respective inverse squared distance to generate weighted performance ratios, and multiplies the first value for the performance metric by the weighted performance metric ratios to generate the value of the performance metric.

Example 21 includes a method comprising comparing, by executing instructions with at least one processor, first products associated with first products data and second products associated with second products data to identify (a) at least one target product corresponding to ones of the second products that are in the first products data, and (b) third products data including third products corresponding to ones of the first products that are the same as ones of the second products, generating, by executing instructions with the at least one processor, a cluster output that includes product clusters of ones of the third products that are similar by clustering the third products based on at least one metric, calculating, by executing instructions with the at least one processor, performance metric ratios, ones of the performance metric ratios corresponding to respective ones of the product clusters, the ones of the performance metric ratios calculated based on the first products data and the second products data, and predicting, by executing instructions with the at least one processor, a value of a performance metric for the at least one target product based data on the second products data and the ones of the performance metric ratios.

Example 22 includes the method of example 21, wherein the first products associated with the first products data correspond to a channel of interest, and wherein the second products associated with the second products data correspond to a reference channel.

Example 23 includes the method of any preceding example wherein the first products and the second products are associated with a category of products, the target product.

Example 24 includes the method of any preceding example wherein, prior to clustering the third products, the method further including removing ones of the third products from the third product data that correspond to first products data associated with a date beyond a threshold period of time.

Example 25 includes the method of any preceding example further including removing ones of the third products from the third product data that correspond to second products data associated with a date beyond a threshold period of time.

Example 26 includes the method of any preceding example wherein the third products are clustered using a k-means clustering technique.

Example 27 includes the method of any preceding example wherein a number of clusters is determined using a silhouette method.

Example 28 includes the method of any preceding example wherein the third products are clustered based on the second products data associated with the reference channel.

Example 29 includes the method of any preceding example wherein, to determine the value of the performance metric for the product of interest, the method includes identifying a first value for the performance metric the at least one target product from the second products data, and multiplying the first value for the performance metric by the ones of the performance metric ratios.

Example 30 includes the method of any preceding example wherein, prior to multiplying the first value for the performance metric by the ones of the performance metric ratios, the method further including adding the at least one target product to the cluster output, determining a distance of ones of the product clusters to the at least one target product, determining an inverse squared distance of the ones of the product clusters to the at least one target product, multiplying the ones of the performance metric ratios for the product clusters by a respective inverse squared distance to generate weighted performance metric ratios, and multiplying the first value for the performance metric by the weighted ratios of the product clusters to generate the value of the performance metric.

The following claims are hereby incorporated into this Detailed Description by this reference. Although certain example systems, methods, apparatus, and articles of manufacture have been disclosed herein, the scope of coverage of this patent is not limited thereto. On the contrary, this patent covers all systems, methods, apparatus, and articles of manufacture fairly falling within the scope of the claims of this patent.

1. An apparatus comprising:
memory;
machine readable instructions; and
processor circuitry to execute the machine readable instructions to at least:
compare first products data associated with a first channel and second products data associated with a second channel to identify (a) a product of interest corresponding to a product present only in the second products data, and (b) common products data corresponding to common products that are present in both the first products data and the second products data;
cluster the common products based on at least one metric to generate product clusters in a cluster output;
for ones of the product clusters in the cluster output, calculate a ratio of a performance metric of the common products based on the first products data to the second products data; and
determine a value of a performance metric for the product of interest based on the second products data and at least one ratio of the performance metric of the common products.

2. The apparatus of claim 1, wherein the first channel is a channel of interest, and wherein the second channel is a benchmark channel.

3. The apparatus of claim 1, wherein the first products data includes data corresponding to first products associated with a category of products, the data corresponding to the first products associated with the first channel.

4. The apparatus of claim 3, wherein the second products data includes data corresponding to second products associated with the category of products, the data corresponding to the second products associated with the second channel.

5. The apparatus of claim 1, wherein, prior to clustering the common products, the processor circuitry is to execute the instructions to remove ones of the common products from the common products data associated with data collected beyond a defined period of time.

6. The apparatus of claim 1, wherein the processor circuitry is to execute the instructions to cluster the common products using a k-means clustering technique.

7. The apparatus of claim 6, wherein the processor circuitry is to execute the instructions to determine a number of clusters using at least one of an elbow method or a silhouette method.

8. The apparatus of claim 1, wherein the processor circuitry is to execute the instructions to cluster the common products based on the second products data associated with the second channel.

9. The apparatus of claim 1, wherein, to determine the value of the performance metric for the product of interest, the processor circuitry is to execute the instructions to:
identify a first value for the performance metric for the product of interest from the second products data; and
multiply the first value for the performance metric by the at least one ratio.

10. The apparatus of claim 9, wherein, prior to multiplying the first value for the performance metric by the at least one ratio, the processor circuitry is to execute the instructions to:
add the product of interest to the cluster output;
determine a distance of ones of the product clusters to the product of interest;
determine an inverse squared distance of the ones of the product clusters to the product of interest;
multiply ones of the ratios of the performance metric for the product clusters by a respective inverse squared distance to generate weighted ratios of the performance metric; and
multiply the first value for the performance metric by the weighted ratios of the product clusters to generate the value of the performance metric.

11. A non-transitory machine readable storage medium comprising instructions that, when executed, cause processor circuitry to at least:
compare a first dataset associated with a focus channel and a second dataset data associated with a reference channel to identify (a) a target product corresponding to a product present in the second dataset and not in the first dataset, and (b) proxy products corresponding to products present in the first dataset and the second dataset;
cluster the proxy products into product clusters based on at least one metric to generate a cluster output that includes the product clusters;
for ones of the product clusters in the cluster output, determine a ratio of a performance metric of the proxy products based on data from the first dataset to data from the second dataset to generate performance metric ratios; and
predict a value of a performance metric for the target product based on data from the second dataset and at least one performance metric ratio of the performance metric ratios.

12. The non-transitory machine readable storage medium of claim 11, wherein the target channel is a channel of interest, and wherein the reference channel is a benchmark channel.

13. The non-transitory machine readable storage medium of claim 11, wherein the first dataset includes data corresponding to first products associated with a category of products, the data corresponding to the first products associated with the target channel.

14. The non-transitory machine readable storage medium of claim 13, wherein the second products data includes data corresponding to second products associated with the category of products, the data corresponding to the second products associated with the reference channel.

15. The non-transitory machine readable storage medium of claim 11, wherein, prior to clustering the proxy products, the processor circuitry is to remove ones of the proxy products having data corresponding to the performance metric that is associated with a date beyond a threshold period of time.

16. The non-transitory machine readable storage medium of claim 11, wherein the proxy products are clustered using a k-means clustering technique.

17. The non-transitory machine readable storage medium of claim 11, wherein a number of clusters is determined using an elbow method.

18. The non-transitory machine readable storage medium of claim 11, wherein the proxy products are clustered based on data from the second dataset associated with the reference channel.

19. The non-transitory machine readable storage medium of claim 11, wherein, to predict the value of the performance metric for the target product, the processor circuitry:
identifies a first value for the performance metric for the target product based on data from the second dataset; and
multiplies the first value for the performance metric by the at least one performance metric ratio.

20. The non-transitory machine readable storage medium of claim 19, wherein, prior to multiplying the first value for the performance metric by the at least one performance ratio, the processor circuitry:
adds the target product to the cluster output;
determines a distance of ones of the product clusters to the target product;
determines an inverse squared distance of the ones of the product clusters to the target product;
multiplies ones of the performance metric ratios for the product clusters by a respective inverse squared distance to generate weighted performance metric ratios; and
multiplies the first value for the performance metric by the weighted performance metric ratios to generate the value of the performance metric.

21. A method comprising:
comparing, by executing instructions with at least one processor, first products associated with first products data and second products associated with second products data to identify (a) at least one target product corresponding to ones of the second products that are in the first products data, and (b) third products data including third products corresponding to ones of the first products that are the same as ones of the second products;
generating, by executing instructions with the at least one processor, a cluster output that includes product clusters of ones of the third products that are similar by clustering the third products based on at least one metric;
calculating, by executing instructions with the at least one processor, performance metric ratios, ones of the performance metric ratios corresponding to respective ones of the product clusters, the ones of the performance metric ratios calculated based on the first products data and the second products data; and
predicting, by executing instructions with the at least one processor, a value of a performance metric for the at least one target product based on the second products data and the ones of the performance metric ratios.

22. The method of claim 21, wherein the first products associated with the first products data correspond to a channel of interest, and wherein the second products associated with the second products data correspond to a reference channel.

23. The method of claim 21, wherein the first products and the second products are associated with a category of products corresponding to the at least one target product.

24. The method of claim 21, wherein, prior to clustering the third products, the method further including removing ones of the third products from the third product data that correspond to first products data associated with a date beyond a threshold period of time.

25. The method of claim 24, further including removing ones of the third products from the third product data that correspond to second products data associated with a date beyond a threshold period of time.

26.-28. (canceled)

29. The method of claim 21, wherein, to determine the value of the performance metric for the target interest, the method includes:
identifying a first value for the performance metric the at least one target product from the second products data; and
multiplying the first value for the performance metric by the ones of the performance metric ratios.

30. The method of claim 29, wherein, prior to multiplying the first value for the performance metric by the ones of the performance metric ratios, the method further including:
adding the at least one target product to the cluster output;
determining a distance of ones of the product clusters to the at least one target product;
determining an inverse squared distance of the ones of the product clusters to the at least one target product;
multiplying the ones of the performance metric ratios for the product clusters by a respective inverse squared distance to generate weighted performance metric ratios; and
multiplying the first value for the performance metric by the weighted ratios of the product clusters to generate the value of the performance metric.
